(19) United States
(12) Patent Application Publication
(10) Pub. No.: US 2024/0303487 A1
(43) Pub. Date: Sep. 12, 2024

(54) MULTIMODAL MACHINE LEARNING MODEL FOR DATA INCLUDING EXAMPLES WITH MISSING MODALITIES

(71) Applicant: Royal Bank of Canada, Toronto (CA)

(72) Inventors: Zhitian ZHANG, Vancouver (CA); Wenjie ZI, Toronto (CA); Yunduz RAKHMANGULOVA, Vancouver (CA); Saghar IRANDOUST, Vancouver (CA); Hossein HAJIMIRSADEGHI, Vancouver (CA); Thibaut DURAND, Vancouver (CA)

(21) Appl. No.: 18/597,777

(22) Filed: Mar. 6, 2024

Related U.S. Application Data
(60) Provisional application No. 63/450,551, filed on Mar. 7, 2023.

(51) Int. Cl. G06N 3/08; G06N 3/0455

(52) U.S. Cl. CPC G06N 3/08; G06N 3/0455

(57) ABSTRACT

Multimodal training data comprising samples of a prediction target is received. Each sample includes at least a subset of the full set of a plurality of modalities, and the samples collectively include instances of each modality. An attention-based encoder receives sets of training vectors for the samples in fixed-dimensional input vector format, and generates a fixed-dimensional vector representation template for the prediction target. The number of dimensions in the template is constant and is independent of the number of modalities represented by the training vectors. The attention-based encoder uses the samples and the fixed-dimensional vector representation template to generate, from the training vectors for the samples, a latent distribution. The samples in fixed-dimensional input vector format and the latent distribution are used as input to a second attention-based neural network to generate an attention-based decoder that can predict from samples with missing modalities.

### CROSS-REFERENCE TO RELATED APPLICATION

This application claims the benefit of U.S. Provisional Application No. 63/450,551 filed on Mar. 7, 2023, the teachings of which are hereby incorporated by reference.

### TECHNICAL FIELD

The present disclosure relates to multimodal machine learning, and more particularly to training machine learning systems to be able to handle data with missing modalities.

### BACKGROUND OF THE INVENTION

Predicting the future is usually a challenging problem that requires an understanding of the surrounding environment. For example, self-driving cars need to understand the trajectory of the other agents (e.g. other cars, pedestrians, bikes, etc.) in the environment to make safe decisions. Modeling and understanding the surrounding environment is a very challenging task because the environment is usually complex and its perception is inherently multimodal—human beings see objects, hear sounds, feel texture, smell odors, etc. Each type of input is considered a modality. A multitude of sensors have been developed to help machines capture different parts of the environment. This is especially true in applications like autonomous driving and video analysis where it is necessary to understand and reason over several modalities to solve a problem. For instance, autonomous navigation algorithms can incorporate multiple types of sensor data, such as LiDAR, camera, GPS, gyroscope, and odometer, to make more informed decisions. Again, each of these inputs is considered a modality, and machine learning approaches that can handle multiple modalities are referred to as multimodal machine learning.

Multimodal machine learning has become the dominant approach in multiple areas of computer vision. Many existing multimodal models require modal-complete data; i.e. they work only if all the examples have all the modalities during both training and inference. This constraint imposes difficulties in real world applications and limits the use cases. Not all current multimodal machine learning models will fail to predict from examples with missing modalities, but may suffer from significant performance degradation where a modality is missing. Returning to the example of autonomous navigation, in some situations the algorithms may not have access to all sensor data because of a sensor outage. Using multiple-redundant sensors is not an adequate solution because of both increased cost as well as the risk of environmental interference (e.g. a mud splatter may obscure multiple-redundant cameras or snow may obstruct accurate LiDAR sensing even where multiple LiDAR sensors are present). In some areas, like healthcare, the acquisition cost of the modalities is not uniform. Some modalities are more expensive to acquire due to the cost of the sensor, or the sensor availability.

Increasing the size of the training dataset size is one way to improve performance of a machine learning algorithm. However, building a large multimodal dataset can be expensive and time consuming because it requires collecting the data for all modalities, cleaning them and aligning them.

Accordingly, it would be advantageous to have multimodal machine learning approaches that can handle data with missing modalities at both training time and inference time.

### SUMMARY

In one aspect, a method is provided for training a first machine learning model to handle multimodal data including examples with missing modalities. The method comprises receiving a plurality of multimodal training data comprising a plurality of samples of a prediction target. Each sample includes at least a subset of a full set of modalities, wherein the full set of modalities is a plurality of modalities, and the samples collectively include instances of each modality within the full set of modalities. The method further comprises using the training data as input to a first attention-based neural network, comprising processing the training data to extract, for each modality in the full set of modalities, a fixed-dimensional input vector format representing that modality to generate a respective feature encoder for each modality in the full set of modalities, and generating an attention-based encoder. The attention-based encoder receives sets of training vectors in the fixed-dimensional input vector format, wherein each set of training vectors represents one of the samples, and generates, from the training vectors for the samples, a fixed-dimensional vector representation template for the prediction target, wherein the number of dimensions in the fixed-dimensional vector representation template is constant and is independent of the number of modalities represented by the training vectors for the samples. The attention-based encoder uses the samples and the fixed-dimensional vector representation template to generate, from the training vectors for the samples, a latent distribution. The method further comprises using representations of the samples of the prediction target according to the fixed-dimensional input vector format and the latent variable from the latent distribution as input to a second attention-based neural network to generate an attention-based decoder. The attention-based decoder is adapted to receive representations of the examples of the prediction target according to the fixed-dimensional input vector format, and generate, from the representations of the examples of the prediction target according to the fixed-dimensional input vector format and the latent variable from the latent distribution, predictions for the examples of the prediction target.

In some embodiments, the attention-based decoder is part of the first machine learning model and the method further comprises using the training data to train the attention-based decoder jointly with generating the attention-based encoder. In other embodiments, the attention-based decoder is part of a second machine learning model that is different from the first machine learning model, and the second machine learning model is trained independently in a separate operation from generating the attention-based encoder.

In some embodiments, the attention-based encoder comprises a plurality of transformer layers. In particular embodiments, each transformer layer may comprise a multihead self-attention (MSA) portion, a layer normalization (LN) portion and a multilayer perceptron (MLP) portion applied using residual connections.

The fixed-dimensional vector representation template may have a dimensionality that is greater than the number of the full set of modalities, fewer than the number of the full set of modalities, or equal to the number of the full set of modalities.

In certain preferred embodiments, the plurality of modalities is at least three modalities.

In another aspect, the present disclosure is directed to a computer program product comprising at least one tangible non-transitory computer-readable medium embodying instructions which, when implemented by at least one processor of a computer, cause the computer to carry out any of the methods as described above.

In a further aspect, the present disclosure is directed to a data processing system comprising at least one processor and memory embodying instructions which, when implemented by the at least one processor, cause the data processing system to carry out any of the methods as described above.

### BRIEF DESCRIPTION OF THE DRAWINGS

These and other features will become more apparent from the following description in which reference is made to the appended drawings wherein:

FIG. 1 shows an overall architecture of a first illustrative model according to the present disclosure;

FIG. 1A shows an overall architecture of a second illustrative model according to the present disclosure;

FIG. 2 shows an illustrative non-limiting example of a multimodal CVAE model according to an aspect of the present disclosure;

FIG. 2A shows another representation of the CVAE model shown in FIG. 2, emphasizing different aspects of the CVAE model;

FIG. 3 shows operation of the transformer decoder of FIGS. 2 and 2A;

FIG. 4 is a flow chart showing an illustrative method for training a first machine learning model to handle multimodal data including examples with missing modalities according to an aspect of the present disclosure;

FIG. 5 shows visualizations of the latent distribution for the MuJoCo Push dataset with both complete and missing modalities; and

FIG. 6 is a block diagram of an illustrative computer system in association with which aspects of the present disclosure may be implemented.

### DETAILED DESCRIPTION

Machine learning models that can work on examples with missing modalities during both training and inference have at least two distinct advantages. First, during the training phase, it is possible to improve the model performance by training the model on a larger dataset. It is easier and less costly to build a large multimodal dataset where some samples have missing modalities. Examples with one or more missing modalities should not be ignored during training because they can contain valuable information. Second, during the inference phase, the model will be robust to examples with a missing modality; i.e. the model can predict effectively from examples with one or more missing modalities. For example, if one of the sensors has an outage or its data is disqualified due to detected environmental interference, which is quite frequent in real world applications, the model will not break—instead the model can continue to make predictions. Although the quality of a prediction made from an example with one or more missing modalities may be lower than a prediction made with all the modalities, in many applications a lower accuracy prediction is still preferable to a total failure to predict at all.

The present disclosure describes a new model architecture, using attention, that can handle multimodal examples with missing modalities during both training and inference. The model is not limited to two modalities and can work on tasks with more than two modalities, that is, three or more modalities. For purposes of illustration and not limitation, instantiations of the model for trajectory prediction tasks are described, and embodiments of the model evaluated on multimodal trajectory prediction datasets with missing modalities to show that the model outperforms existing baselines. Models according to the present disclosure are not limited to trajectory prediction, and have a wide range of applications.

Attention-based models are suitable for processing multimodal data with missing modalities because these models can handle multiple modalities with a single backbone network and can handle a variable number of inputs. Many of the prior art multimodal models only work if all of the modalities are available during both training and inference. As noted above, this is limiting because many real multimodal datasets have examples with some missing modalities.

The present disclosure describes an attention-based multimodal model designed to handle examples with missing multimodalities during both training and inference. An illustrative, non-limiting embodiment of the model is formulated as a Conditional Variational AutoEncoder (CVAE) and is trained on multimodal examples with missing inputs.

Specifically, all the modalities are presented in the training dataset, but examples in the training dataset can have a missing modality.

### Method Overview

Temporal multimodal forecasting with missing modalities is formulated as a generative modeling process in which the goal is to learn a model of conditional probability distribution of the future with any number of given multimodal inputs from the past. Suppose for a multimodal time series dataset, given matrix Xϵ [symbol] ^{n×t} represents the historical multimodal data with N number of features for a period of time t. And X_{N}^{t}={x₁⁰, . . . , x₁^{t}, . . . , x_{N}⁰, . . . , x_{N}^{T}}, where xₙ^{t} represents modality n at time t. The future target sequence over T future timesteps is denoted as Y={y^{t+1}, y^{t+2}, . . . y^{t+T}}. The desired probability distribution can then be defined as p_{θ}(Y|X), when there is no missing modality. In a situation where a modality is missing, X becomes X_{N-1}={x₁⁰, . . . , x₁^{t}, . . . , x_{N-1}⁰, . . . , x_{N-1}^{t}}, and the distribution p_{θ}(Y|X_{N-1}) is modeled as close as possible to p_{θ}(Y|X).

### Overview of an Illustrative Embodiment of the Model

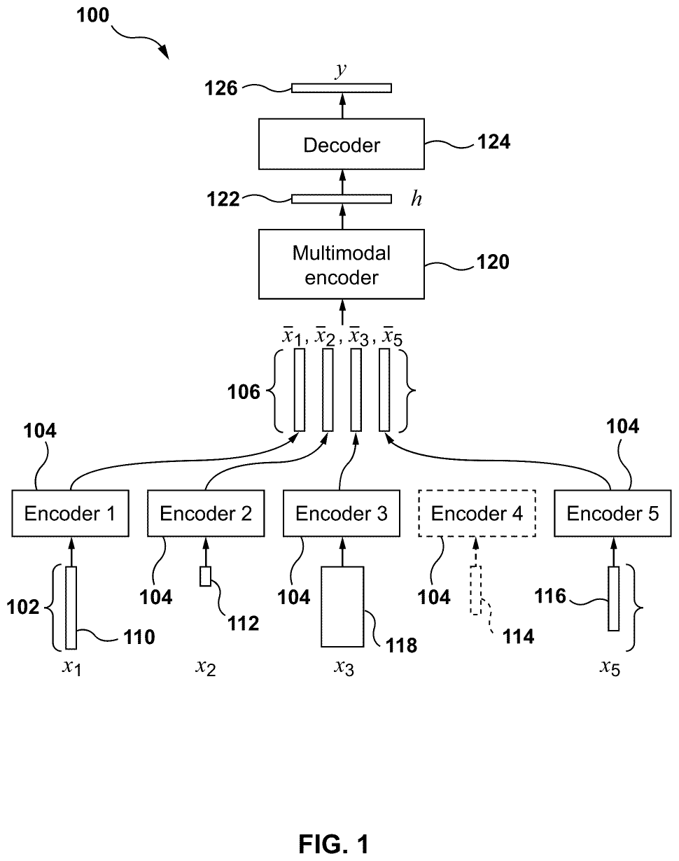

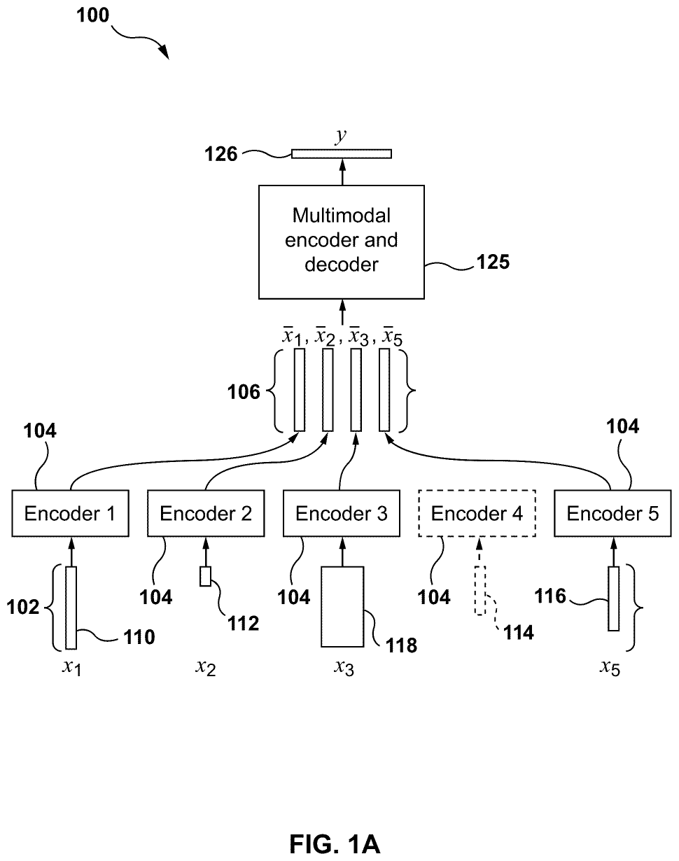

FIG. 1 shows the overall architecture of an illustrative embodiment of the model 100 with five modalities 102. The model 100 makes predictions based on the available inputs and the model 100 can work if inputs for one or more of the modalities are missing. For each of the five modalities, a respective feature encoder 104 learns fixed-dimension input vector formats 106 of the respective inputs associated with that modality 102. In the illustrated embodiment, the inputs associated with the modalities 102 comprise vectors 110, 112, 114 and 116 of variable dimensions and an image 118. This is merely an illustrative embodiment and is not limiting; the model can adapt to a wide range of input types and can have any plural number of modalities.

Then, an attention-based model learns a fixed-dimension vectorial representation of the set of features represented by the modalities 102 to form a multimodal encoder 120. The fixed-dimension vectorial representations 106 of the inputs are fed to the multimodal encoder 120, which generates a feature sequence h 122, which is then fed to a decoder 124 to generate a decoded future sequence y 126.

As noted above, the model according to the present disclosure can handle multimodal examples with missing modalities during both training and inference. FIG. 1 shows an example where there are only four inputs 110, 112, 116 and 118, denoted as {x₁, x₂, x₃, x₅}. The fourth input 114, which would be x₄, is missing and this missing fourth input 114 and its associated feature encoder 104 are represented with dashed lines; the model 100 can both train and predict despite this missing input. Again, FIG. 1 is merely illustrative; the model 100 according to the present disclosure can handle more than one missing input.

FIG. 1A shows an alternate embodiment in which the multimodal encoder and multimodal decoder are combined into a multimodal encoder and decoder 125; otherwise like references denote like features in FIGS. 1 and 1A.

The present disclosure describes a framework that is capable of dealing with missing input data while maintaining a similar performance without retraining or any modification to the network. The attention mechanism is used to combine multimodal input features into a latent distribution. The attention mechanism can be described as y=σ(QK T)V where Q,K,V are Query, Key and Value matrices and σ( ) is a non-linear function. The attention mechanism is used to compute the attention between each of the modalities. For most scenarios in self-attention operations, a missing modality from an input X will result in changing the number of rows in Q,K,V and eventually affecting the dimension of output size. The methodology described herein adopts the Set Transformer and replaces Q with a fixed-size learnable random variable in the attention mechanism. Thus, methods according to the present disclosure provide for training a first machine learning model to handle multimodal data including examples with missing modalities.

### Conditional Variational AutoEncoder (CVAE)

An illustrative CVAE model consists of two major components: a transformer encoder, parameterized by θ, takes the input {X} and produces a distribution p_{θ}(z|X) where z is a latent variable; and a transformer decoder, parameterized by ϕ, uses {X} and samples from p_{θ}(z|X) to infer p_{ϕ}(p(Y|X, z). To obtain the future probability distribution p(Y|X), latent variable z is marginalized out:

$$p ( Y \vert X ) = {\sum }_{z} {p}_{ϕ} ( Y \vert X , z ) {p}_{θ} ( z \vert X ) \qquad ( 1 )$$

If there is a missing modality in X, the transformer encoder approximates the distribution p_{θ}(z|X) with input X_{N-1}, and the decoder approximates the distribution p_{ϕ}(Y|X, z) so that the desired distribution p(Y|X) does not vary dramatically.

### Transformer Encoder

A series of temporal feature encoders Eₚ is used to encode the past temporal information from multimodal input X, where Eₚ={Eₚ¹, Eₚ², . . . , Eₚ^{N}} and Eₚⁿ represents the temporal encoder for modality n. The output of the temporal feature encoder is a past feature sequence Eₚ(X)={Eₚ¹(X₁^{t}), Eₚ²(X₂^{t}), . . . , Eₚ^{N}(X_{N}^{t})}. Unlike previous works where the feature sequences are normally concatenated together, a stacking operation is performed to obtain the final representation R as the input to the transformer encoder. The stacking operation creates a new dimension, where the final representation R will have N number of rows if there are N number of modalities. The final representation R is passed into the transformer encoder E_{T}, which consists of a sequence of L transformer layers. Each transformer layer consists of Multi-Head Self-Attention (MSA), Layer Normalization (LN) and Multilayer Perceptron (MLP) applied using residual connections. An encoder transformer layer, Rⁿ⁺¹=Transformerₑ(Rⁿ) is denoted as

$$\begin{matrix}{U}^{n} = MSA ( LN ( {R}^{n} ) ) + {R}^{n} , \\ {R}^{n + 1} = MLP ( LN ( {U}^{n} ) ) + {U}^{n}\end{matrix} \qquad ( 2 )$$

where the MSA computes the dot-product attention of input representation Rⁿ. The same final representation R is used for queries, keys and values of the MSA, which gives MSA(R)=Attention(W^{Q}R, W^{K}R, W^{V}R). To define the transformer encoder E_{T}:

$${E}_{T} ( R ; θ ) = {\sum }_{L}^{0} {Transformer}_{e} ( {R}^{L} ) \qquad ( 3 )$$

The output of the transformer encoder E_{T}(R; θ) will then be flattened and passed through a MLP layer to produce parameters (μ, σ) for encoding the latent variable z= [symbol] (μ, σ) of the CVAE. Later, sampling from this distribution [symbol] (μ, σ), along with other representations, yields the prediction for the future (e.g. a future trajectory). The ground-truth endpoint should only be used during training time and should not be available during testing or inference. Therefore at test or inference time, z is sampled from [symbol] (μ=0, σ=I).

### Transformer Decoder

Because some modalities are not available for prediction, the same transformer encoder E_{T} may be used once again to combine the available modalities, and attend to important information across modalities. Suppose there are η number of available modalities for the decoding process, where η≤N. The feature sequence for the decoder is given by H={H₁, H₂, . . . , H_{η}}, where H_{η}=Eₚ^{η}(X_{η}), Hϵ [symbol] ^{η×d}, and d is the embedding dimension. The multimodal decoder forecasts future sequence based on both feature sequence H and the latent variable z.

The transformer decoder D_{T} has a similar structure to the transformer encoder E_{T}; the main difference is that the attention mechanism in the transformer layers use different queries, keys and values to compute the projection matrices. Queries Q, keys K and values V are defined as the input to the transformer decoder D_{T}:

$$\begin{matrix}K = [ {f}_{k} ( {H}_{1} , z ) , {f}_{k} ( {H}_{2} , z ) , … , {f}_{k} ( {H}_{η} , z ) ] , \\ V = [ {H}_{1} , {H}_{2} , … {H}_{η} ]\end{matrix} \qquad ( 4 )$$

Equation 4 shows that K is a representation generated by a function ƒₖ. For the queries Q, a fixed size learnable matrix is generated from a normal distribution, which always has a size of Qϵ [symbol] ^{N×d}. This Multi-Head Attention operation is defined as MHA, and MHA(O)=Attention(W^{Q}Q, W^{K}K, W^{V}V), where O is used to represent {Q, K, V}, the input to the decoder. And therefore the transformer layer, Oⁿ⁺¹=Transformer_{d}(Oⁿ), of the decoder becomes:

$$\begin{matrix}{n}^{} = MHA ( LN ( {O}^{n} ) ) + {O}^{n} , \\ {O}^{n + 1} = MLP ( LN ( {n}^{} ) ) + {n}^{}\end{matrix} \qquad ( 5 )$$

Then, the transformer decoder D_{T} can be written as:

$$\begin{matrix}{D}_{T} ( O ; ϕ ) = {\sum }_{L}^{0} {Transformer}_{d} ( {O}^{L} ) , \\ where Q = {Transformer}_{d} ( {O}^{L - 1} ) for L > 1\end{matrix} \qquad ( 6 )$$

Similarly, flattening operations are performed on D_{T}(O; ϕ) and then input to an MLP to obtain the decoded future sequence Ŷ.

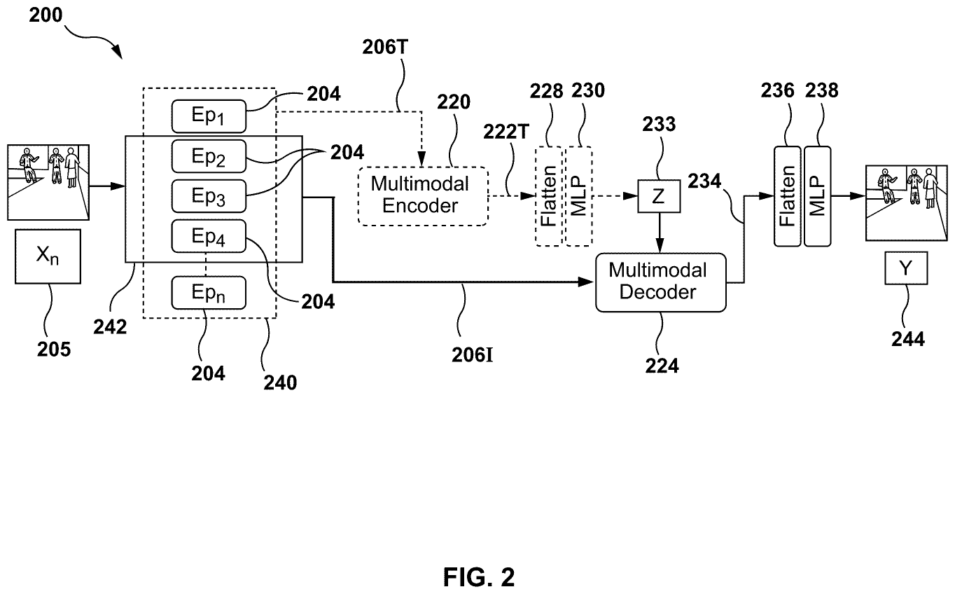

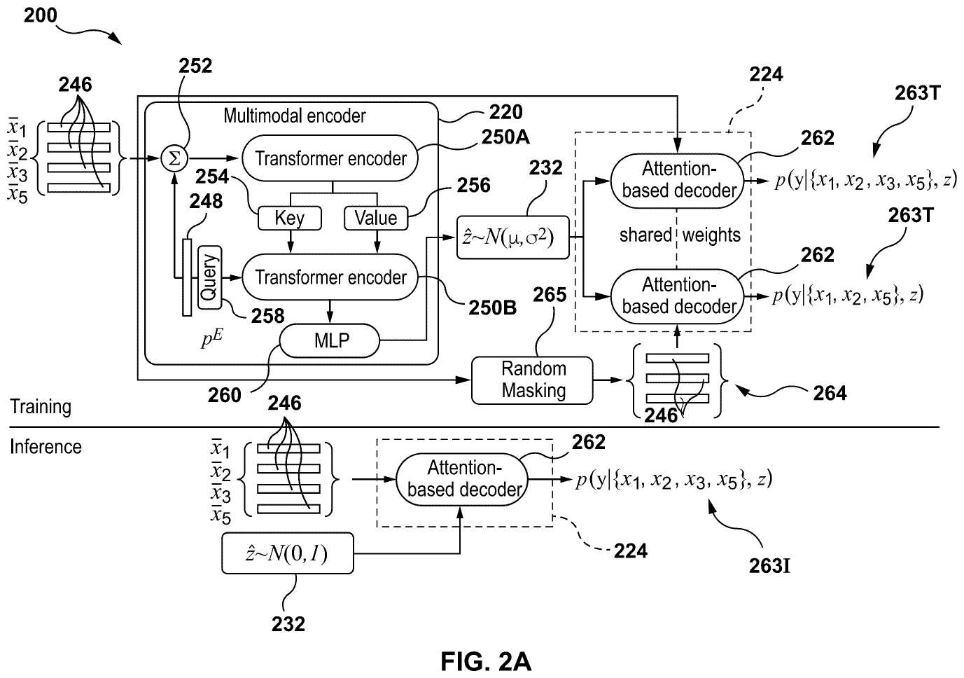

A multimodal CVAE model according to the present disclosure, an illustrative non-limiting example of which is shown in FIG. 2, is able to learn representations from an arbitrary number of multimodal inputs and still approximate the desired probability distribution p_{θ}(Y|X). In FIG. 2, solid lines represent aspects used for both training and testing/prediction; dashed lines represent aspects used for training only.

In the illustrative model 200 shown in FIG. 2, a series of temporal feature encoders 204 encode the temporal information from a multimodal input 205. During training, the multimodal input 205 is a plurality of multimodal training data. The training data comprises a plurality of samples of a prediction target, that is, a particular thing to be predicted. As used herein, the term “sample” is used to refer to instances of the prediction target in the training data and the term “example” is used to refer to instances of the prediction target for which a prediction is to be made at inference time. One illustrative non-limiting example of a prediction target is a human trajectory; the model 200 may be applied to a wide range of prediction targets.

Each sample in the multimodal training data includes at least a subset of the full set of modalities; the full set of modalities is a plurality of modalities and preferably at least three modalities. The samples in the multimodal training data collectively include instances of each modality within the full set of modalities. Thus, where the full set of modalities is, for example, X_{N}^{t}={x₁⁰, . . . , x₁^{t}, . . . , x_{N}⁰, . . . , x_{N}^{t}}, where xₙ^{t} represents modality n at time t, any individual sample may be missing any one or more of the modalities, so that X becomes X_{N-1}={x₁⁰, . . . , x₁^{t}, . . . , x_{N-1}⁰, . . . , x_{N-1}^{t}}, so long as the samples in the multimodal training data collectively represent the full set of modalities X_{N}^{t}={=x₁⁰, . . . , x₁^{t}, . . . , x_{N}⁰, . . . , x_{N}^{t}}, i.e. there is no modality for which none of the samples contain inputs for that modality.

The training data is processed to extract, for each modality in the full set of modalities, a fixed-dimensional input vector format representing that modality to generate the respective feature encoder 204 for that modality, so that there is a respective temporal feature encoder 204 for each modality in the full set of modalities. The training data is used as input to a first attention-based neural network to generate an attention-based encoder, in this case a multimodal encoder 220. The multimodal encoder 220 may comprise a transformer encoder.

The output of the temporal feature encoders 204 is stacked to obtain a final representation 206T as the input to the multimodal encoder 220. In one embodiment, the multimodal encoder 220 comprises a plurality of transformer layers. In a particular embodiment, each transformer layer comprises a multihead self-attention (MSA) portion, a layer normalization (LN) portion and a multilayer perceptron (MLP) portion applied using residual connections.

At training time, the multimodal encoder 220 receives samples; the samples take the form of sets of training vectors in the fixed-dimensional input vector format, with each set of training vectors representing one of the samples from the multimodal training data. Also at training time, the multimodal encoder 220 generates, from the training vectors for the samples, a fixed-dimensional vector representation template for the prediction target. The number of dimensions (dimensionality) in the fixed-dimensional vector representation is constant and is independent of the number of modalities represented by the training vectors for the samples. For example, the number of dimensions in the fixed-dimensional vector representation template may be greater than the number of modalities in the full set of modalities, fewer than the number of modalities in the full set of modalities, or equal to the number of modalities in the full set of modalities.

In the illustrated embodiment shown in FIG. 2, a prediction engine in the form of a multimodal decoder 224 is provided as part of the same machine learning model as the multimodal encoder 220 (which is an attention-based encoder), and the training data is used to train the multimodal decoder 224 jointly with generating the attention-based encoder. More particularly, in the illustrated embodiment shown in FIG. 2 the multimodal decoder 224 is an attention-based decoder.

At training time, the output 222T of the multimodal encoder 220 is flattened 228 and passed through an MLP layer 230 to produce parameters for encoding the latent distribution 232 (see FIG. 2A) of the CVAE model. Thus, the multimodal encoder 220 generates, from the training vectors for the samples, a latent distribution 232 (see FIG. 2A).

At training time, both the output 2061 of the temporal feature encoders 204 and the latent variable 233 from the latent distribution 232 (see FIG. 2A) are used as input to a second attention-based neural network to generate the multimodal decoder 224. Thus, both the multimodal encoder 220 and the multimodal decoder 224 are generated by processing the multimodal training data in an attention-based neural network. To generate the latent variable 233 at training time, all modalities encoded by the separate and independent temporal feature encoders 204 are used, as shown by the dashed box 240.

After training, the multimodal decoder 224 is adapted to receive representations of examples of the prediction target according to the fixed-dimensional input vector format, and to generate, from the representations of the examples of the prediction target and the latent variable 233, predictions for the examples of the prediction target.

At inference time, the temporal feature encoders 204 encode the temporal information from a multimodal input 205 where the multimodal input 205 is an example of a prediction target for which a prediction is sought. If there are missing modalities, the available modalities and associated temporal feature encoders 204 are used, as shown by the solid box 242. This particular solid box 242 is merely illustrative and not limiting. The output of the temporal feature encoders 204 is stacked to obtain a final representation 2061 as the input to the multimodal decoder 224. Thus, at inference time, the multimodal decoder 220 receives examples in the form of sets of input vectors in the fixed-dimensional input vector format. Each set of input vectors represents an example of the prediction target that includes at least a subset of a full set of modalities. Some examples may include all modalities, while other examples may be missing one or more modalities. The output 234 of the multimodal decoder 224 is flattened 236 and then input to an MLP layer 238 to obtain the decoded future sequence 244. The multimodal decoder 224 may comprise a transformer decoder.

The embodiment described above is merely one illustrative example of an arrangement in which the multimodal decoder is part of the same machine learning model as the multimodal encoder. Other embodiments are contemplated. For example, a prediction engine may be a trained neural network, and using the training data to train the prediction engine may comprise using the representations of the samples according to the fixed-dimensional input vector format to train an untrained neural network to produce the trained neural network, which may be, for example, a multilayer perceptron (MLP) neural network.

Although in the embodiment shown in FIG. 2 the prediction engine is a multimodal decoder 224 that is part of the same machine learning model as the multimodal encoder 220, methods according to the present disclosure are not so limited. In other embodiments, the prediction engine may be a second machine learning model that is different from the first machine learning model. In such embodiments, the second machine learning model may be trained independently in a separate operation from generating the attention-based encoder.

FIG. 2A shows another representation of the model 200 shown in FIG. 2, emphasizing different aspects of the model 200. The upper portion of FIG. 2A shows the model 200 during training, and the lower portion of FIG. 2A shows the model 200 during inference.

Reference is now made to the upper portion of FIG. 2A. The multimodal encoder 220, which is only used during training, includes two transformer encoder layers 250A, 250B. At training time, the vectors 246 representing the modalities present in the samples are each summed 252 with a position vector 248, which indicates the position of the respective modality, and the resulting final representation is passed to the first transformer encoder layer 250A, which generates key 254 and value 256 as output. The key 254 and value 256 are fed to the second transformer encoder layer 250B as input, along with a query 258 obtained from the position vector 248. The output of the second transformer encoder layer 250B is passed into a multilayer perceptron (MLP) 260 which outputs the latent distribution 232.

In the illustrated embodiment, the multimodal decoder 224 comprises an attention-based decoder 262, which decodes a latent variable sampled from the latent distribution 232 into a conditional probability distribution 263T. Accordingly, in each case, the attention-based decoder 262 receives a latent variable from the latent distribution 232 as input, along with the vectors 246 representing the modalities present in the samples. To train the model 200 to be robust to missing modalities, the latent variable is decoded two times, with two different sets of modalities. Thus, the attention-based decoder 262 is shown twice to represent the use of different inputs into the attention-based decoder 262. The upper representation of the attention-based decoder 262 shows the attention-based decoder 262 receiving the same set of modalities (the vectors 246 representing the modalities present in the samples) received by the multimodal encoder 220. The lower representation of the attention-based decoder 262 shows the attention-based decoder 262 receiving a set of modalities 264 in which one of the modalities (one of the vectors 246) has been removed, for example by random masking 265. This example shows X₃ is removed merely for illustrative purposes; any of the modalities may be removed. The model 200 is trained to minimize the distance between the two conditional probability distributions 263T produced by the attention-based decoder 262.

As shown in the lower portion of FIG. 2A, during inference the attention-based decoder 262 samples a latent variable from the latent distribution 232 and receives a set of vectors 246 representing the available modalities for a sample as input, and outputs a conditional probability distribution 2631.

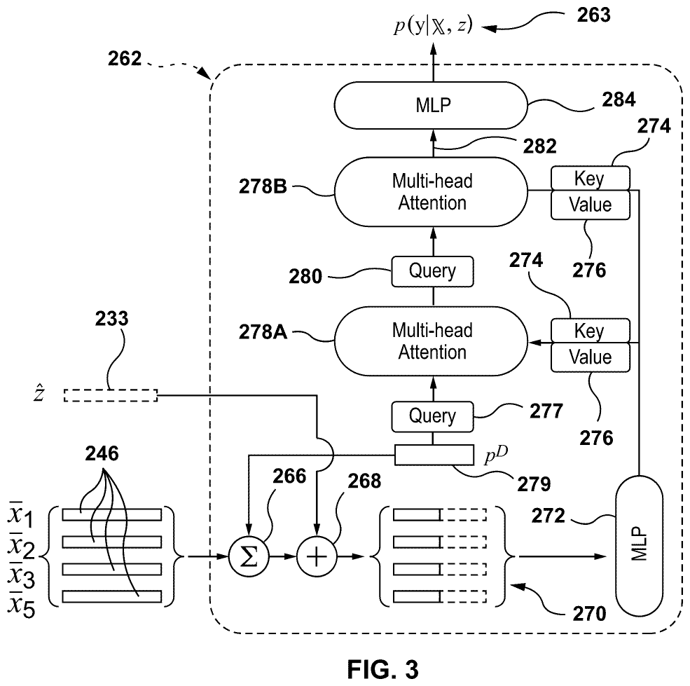

Reference is now made to FIG. 3, which shows an illustrative embodiment of the attention-based decoder 262. The vectors 246 representing the modalities present in the sample are passed to the attention-based decoder 262, and each vector 246 for one of the modalities present is summed 266 with the respective position vector 279. After summation 266, the vectors 246 for those modalities that are present are combined 268, for example concatenated, with the latent variable 233, which is a vector sampled from the latent distribution 232 (FIG. 2A). The resulting joint modality latent representation 270 is passed to a first multilayer perceptron 272, which generates key 274 and value 276. Key 274 and value 276 are passed to a first multi-head attention layer 278A, along with a query 277 obtained from the position vector 279. The query 277 in FIG. 3 is different from the query 248 in FIG. 2A and the position vector 279 in FIG. 3 is different from the position vector 248 in FIG. 2A. The first multi-head attention layer 278A generates a new query 280, which is passed to a second multi-head attention layer 278B, along with the same key 274 and value 276. The result 282 is passed to a second multilayer perceptron 284, which decodes the result 282 to obtain the conditional probability distribution 263.

### Detailed Mathematical Description

A more detailed mathematical description of an illustrative implementation of the model will now be provided.

### Background on Attention

Transformers are built upon attention, which enables the capture of relationships for tokens at different positions. The attention receives three input sequences, namely query Qϵ [symbol] _{q}^{n×d}, key Kϵ [symbol] ₖ^{n×d}, and value Vϵ [symbol] ᵥ^{n×d}, where n_{q}, nₖ and nᵤ are the sequence lengths of query, key and value respectively.

$$Att ( Q , K , V ) = softmax ( \frac{{{Qw}_{Q} ( {KW}_{K} )}^{T}}{\sqrt{{d}_{h}}} ) {VW}_{v} \qquad ( 7 )$$

where W_{q}, Wₖ, Wᵥϵ [symbol] ^{d×d}^{ₕ} are learnable parameters and dh is the number of hidden dimensions. Self-attention (SA) is a special case of attention where Q=K=V:SA(X)=Att (X,X,X). Multihead self-attention (MSA) is an extension of SA in which k self-attention run in parallel, and their concatenated outputs are projected:

$$MSA ( X ) = [ {SA}_{1} ( X ) , {SA}_{2} ( X ) , … , {SA}_{k} ( X ) ] {W}_{o} \qquad ( 8 )$$

where Wₒ are learnable parameters. Similarly, the multihead attention is:

$$MHA ( Q , K , V ) = [ {Att}_{1} ( Q , K , V ) , … , {Att}_{k} ( Q , K , V ) ] {W}_{o} \qquad ( 9 )$$

Denote by M≥1 the number of modalities and [symbol] ={1, . . . , M} the set of all the modalities. Let [symbol] ⁽ⁱ⁾⊂ [symbol] be the set of available modalities associated to the i^{th} example, and M⁽ⁱ⁾ is the number of available modalities. It is assumed that [symbol] ⁽ⁱ⁾ cannot be empty, so each example has at least one modality. Denote the training data by D={( [symbol] ⁽¹⁾, y⁽¹⁾), . . . , ( [symbol] ^{(N)}, y^{(N)})} where [symbol] ⁽ⁱ⁾={xₘ⁽ⁱ⁾}_{mϵ} [symbol] _{⁽ⁱ⁾} is the multimodal representations associated to the i^{th} example, and y⁽ⁱ⁾ is its ground-truth label. xₘ⁽ⁱ⁾ is the unimodal representation of the m^{th} modality of the i^{th} example. The nature of xₘ⁽ⁱ⁾ depends on the modality and each modality can be different i.e. the first modality can be an image, the second one can be a time series and the third one can be a human pose, for example. These are merely illustrative examples and are not limiting. In this embodiment, the focus is on future prediction y⁽ⁱ⁾=(y₁⁽ⁱ⁾, . . . , y_{T}⁽ⁱ⁾) where T is the number of future time steps to predict and y_{T}⁽ⁱ⁾ is the prediction at time step t. In some embodiments, the variable to predict is assumed to be unimodal. The history of the variable to predict may be one of the input modalities of the model.

As noted above, in an illustrative embodiment, the future prediction with missing modalities problem is formulated as a generative model for a set of modalities using a CVAE framework. Without being limited by theory, a Variational Auto-Encoder (VAE) formulation may be used because the objective is to develop a probabilistic model to capture the uncertainty in predicting the future. During training, the goal is to learn a function that outputs the probability distribution over the output y conditional on a set of available modalities [symbol] representing the past p(y| [symbol] ;Θ), where Θ are the whole set of model parameters.

In one embodiment, the goal is to design a model that is able to learn representations from an arbitrary number of multimodal inputs and still model the desired probability distribution p(y| [symbol] ;Θ). Using a VAE formulation, the probability distribution can be written as:

$$p ( y \vert 𝕏 ; Θ ) = {\int }_{z} p ( y \vert 𝕏 , z ; θ ) p ( z \vert 𝕏 ; ϕ ) dz \qquad ( 10 )$$

where p(y| [symbol] , z; θ) is a complex likelihood function parameterized by θ, p(z| [symbol] ; ϕ) is a posterior function parameterized by ϕ, and z is a latent variable. The latent variables model both diversity and uncertainty about the future.

### Training

During training, the goal is to learn the parameters of the conditional generative model. The training process is shown in the upper portion of FIG. 2A and briefly described above. During training, the model takes as input the target y, and the available modalities X. These inputs are used to compute a conditional distribution q(z| [symbol] ; ϕ) from which a latent variable z is sampled. Since the true distribution over latent variables z is intractable, reliance is placed on an amortized inference network q(z| [symbol] ; ϕ) that approximates it with a multivariate conditional Gaussian distribution with diagonal covariance with parameters q(z| [symbol] ; ϕ)= [symbol] (μ_{ϕ}, σ_{ϕ}) where μ_{ϕ} and σ_{ϕ} are functions that estimate the mean and the variance of the approximate posterior. To prevent z from merely copying [symbol] , q(z| [symbol] ; ϕ) is forced to be close to the prior distribution p(z) using a KL-divergence term. A fixed Gaussian [symbol] (0, I) is used as a prior distribution, although in other embodiments a prior distribution may be learned. During training, a latent variable is drawn from the approximate posterior distribution \hat{z}˜q(z| [symbol] ; ϕ). The output prediction ŷ is then sampled from the distribution ŷ˜p(y| [symbol] , \hat{z}; θ) of the conditional generative model.

### Inference

During inference, the goal is to generate a prediction of the future given the available modalities representing the past. The inference (or generation) process is shown on the lower portion of FIG. 2A and is briefly described above. First, a latent variable \hat{z} is sampled from the prior distribution z̅˜p(z). Then, a prediction j is generated as follows: ŷ˜p(y| [symbol] , \hat{z}; θ).

### Learning

The parameters of the generative model θ as well as the amortized inference network ϕ can be jointly optimized by maximizing the evidence lower-bound (ELBO):

$${ℒ}_{ELBO} ( {𝕏}^{( i )} , {y}^{( i )} ) = {𝔼}_{q ( Z \vert {𝕏}^{( i )} ; ϕ )} [ log p ( {y}^{( i )} \vert {𝕏}^{( i )} , z ; θ ] - KL [ q ( z \vert {𝕏}^{( i )} ; ϕ ) ‖ p ( z ) ] \qquad ( 11 )$$

where KL is the Kullback-Liebler divergence between two distributions. The KL divergence between the two Gaussian distributions is computed analytically. The re-parameterization approach described by Diederik P. Kingma and Max Welling in “Auto-Encoding Variational Bayes” in the International Conference on Learning Representations (ICLR), 2014 may be used to sample from the amortized inference network q(z| [symbol] ⁽ⁱ⁾; ϕ).

To train the model to be robust to missing modalities, one of the available modalities is randomly removed, for example by random masking, and the distance between the two distributions is minimized. For a given latent variable, the output distribution should not change materially if one of the modalities is missing.

Let [symbol] ⁽ⁱ⁾= [symbol] _{(i)\{m}} be a subset of the available modalities where m is the removed modality. The KL divergence is used to measure the distance between the two distributions and the loss is:

$${ℒ}_{mis} ( {𝕏}^{( i )} , {{𝕏}^{⌣}}^{( i )} ) = KL [ p ( y \vert {𝕏}^{( i )} , z ; θ ) ‖ p ( y \vert {{𝕏}^{⌣}}^{( i )} , z ; θ ]$$

By analogy to a teacher-student arrangement, the distribution generated with all of the available modalities can be seen as the teacher and the distribution generated with the missing modality can be seen as the student. During training, the parameters are jointly learned in an end-to-end fashion by optimizing both losses.

As described above in the context of FIG. 2, the architecture of the illustrative model 200 includes three main components: the temporal feature encoders 204, which are preferably unimodal encoders, the multimodal encoder 220 and the multimodal decoder 224, which is preferably an attention-based decoder 262 (FIG. 2A). According to one implementation, the unimodal encoders extract a fixed-dimensional vectorial representation for each of the available modalities. Then, the multimodal encoder learns a joint representation and outputs the parameters of the posterior distribution. Finally, an attention-based decoder takes as input a latent variable sampled from the posterior distribution and the set of available modalities to generate the output distribution.

### Unimodal Encoders

Denote by Eₘ the unimodal encoder for the m^{th} modality, and d the dimension of the common space. x̅ₘ⁽ⁱ⁾ϵ [symbol] ^{d} is the fixed-dimensional vectorial representation of the m^{th} modality of the it example. The present embodiment assumes that each modality is encoded separately, but it is possible to extend the model to jointly encode several modalities and such extension is within the capability of one of ordinary skill in the art, now informed by the present disclosure. The output of the unimodal encoders is a set of fixed dimensional vectorial representations:

$${\overline{𝕏}}^{( i )} = {\{ {\overline{x}}_{m}^{( i )} \}}_{𝓂 ∈ {𝕄}^{( i )}} with {\overline{x}}_{m}^{( i )} = {E}_{m} ( {x}_{m}^{( i )} ) ∈ {ℝ}^{d} \qquad ( 13 )$$

The architecture of each unimodal encoder depends on the structure of the modality. For example, a ConvNet can be used to encode an RGB image, and a gated recurrent unit (GRU) can be used to encode a sequence of vectors. These are merely illustrative examples and are not limiting.

### Multimodal Encoder

The goal of the multimodal encoder (e.g. multimodal encoder 220 in FIG. 2) is to model the approximate posterior distribution given the set of available modalities. The illustrative encoder model consists of two layers (e.g. layers 250A, 250B in FIG. 2) of the transformer encoder with some modifications. Unlike most of the transformer models that use an attention mechanism for sequence modeling, an embodiment of the present disclosure leverages the adaptive nature of the attention mechanism to enable learning across available modalities. Preferably, the multimodal encoder is only used during training.

The first layer (e.g. layer 250A) of the illustrative multimodal encoder 220 uses the self-attention mechanism to aggregate features from all modalities and enable learning of adaptive weights over different modalities. First, the available modalities are represented as a sequence of M⁽ⁱ⁾ vectors by using the output of the unimodal encoders. Position embeddings P^{E}=[p₁^{E}, . . . , p_{M}^{E}]ϵ [symbol] ^{M×d} are added to the sequence to retain modality information. The resulting sequence of vectors serves as input to a transformer encoder of L layers. The transformer encoder consists of alternating layers of multihead self-attention (MSA) and multilayer perceptron (MLP). LayerNorm (LN) is applied before every block, and residual connections after every block. The MLP contains a ReLU non-linearity.

$${X}_{0}^{( i )} = {[ {\overline{x}}_{m}^{( i )} + {p}_{m}^{E} ]}_{m ∈ {𝕄}^{( i )}} ∈ {ℝ}^{{M}^{( i )} \times d} \qquad ( 14 )$$

$${X}_{l}^{′ ( i )} = MSA ( L N ( {X}_{l - 1}^{( i )} ) ) + {X}_{l - 1}^{( i )} l = 1 , … , L - 1 \qquad ( 15 )$$

$${X}_{l}^{( i )} = MLP ( L N ( {X}_{l}^{′ ( i )} ) ) + {X}_{l}^{′ ( i )} l = 1 , … , L - 1 \qquad ( 16 )$$

The second layer (e.g. layer 250B) of the illustrative multimodal encoder 220 is designed to handle missing modalities during training time. Features are aggregated over missing modalities by applying multihead attention on a learnable fixed-size embedding. The query Q in the multihead attention operation is made to always have a fixed dimension, so that a change in modality size does not affect the output size. Here, P^{E} is chosen as the query Q.

$${X}_{L}^{′ ( i )} = MHA ( L N ( {P}^{E} ) , L N ( {X}_{L - 1}^{( i )} ) , L N ( {X}_{L - 1}^{( i )} ) ) + {X}_{L - 1}^{( i )} \qquad ( 17 )$$

$${X}_{L}^{( i )} = MLP ( L N ( {X}_{L}^{′ ( i )} ) ) + {X}_{L}^{′ ( i )} \qquad ( 18 )$$

The output X_{L}⁽ⁱ⁾ is flattened 228 (FIG. 2) and passed into the MLP 230 (FIG. 2) ƒ_{ϕ} that outputs the posterior Gaussian distribution parameters:

$${μ}_{ϕ}^{( i )} , {σ}_{ϕ}^{( i )} = {f}_{∅} ( flat ( {X}_{L}^{( i )} ) ) \qquad ( 19 )$$

### Multimodal Decoder

The illustrative multimodal decoder (e.g. attention-based decoder 262 in FIG. 2A) has two inputs: the set of available modalities (e.g. vectors 246) and a latent variable. As with the multimodal encoder, the available modalities are represented as a sequence of M⁽ⁱ⁾ vectors by using the output of the unimodal encoders and position embeddings are added to retain modality information. A latent variable z˜ [symbol] (μ_{ϕ}⁽ⁱ⁾, σ_{ϕ}⁽ⁱ⁾) is sampled from the posterior distribution (or prior during testing). The latent variable is combined with, for example concatenated to, each modality representation:

$${J}^{( i )} = {[ ( {\overline{x}}_{m}^{( i )} + {p}_{m}^{D} ) ⊗ z ]}_{𝓂 ∈ {𝕄}^{( i )}} ∈ {ℝ}^{{M}^{( i )} \times ( d \times {d}_{z} )} \qquad ( 20 )$$

where d_{z} is the dimension of the latent distribution, ⊕ is the concatenation operator and P^{D}=[p₁^{D}, . . . , p_{M}^{D}]ϵ [symbol] ^{M×d} is a learnable position encoding. Similarly to the last layer of the multimodal encoder, some MLPs and multihead attention layers with a learnable fixed-size embedding are used as the query Q to learn a conditional probability distribution of multimodal data. In the illustrative embodiment, P^{D} is used as query Q in the multimodal decoder. By concatenating the latent variable to each modality and processing them through a MLP, the impacts among different modalities may be reduced for the case where there is a missing modality.

$${H}_{0}^{( i )} = MLP ( {J}^{( i )} ) \qquad ( 21 )$$

$${H}_{1}^{( i )} = MHA ( L N ( {P}^{D} ) , LN ( {H}_{0}^{( i )} ) , LN ( {H}_{0}^{( i )} ) ) + {H}_{0}^{( i )} \qquad ( 22 )$$

$${H}_{2}^{( i )} = MHA ( L N ( {H}_{1}^{( i )} ) , N ( {H}_{0}^{( i )} ) , L N ( {H}_{0}^{( i )} ) ) + {H}_{0}^{( i )} \qquad ( 23 )$$

The output H₂⁽ⁱ⁾ is flattened 236 and passed into a MLP 238 that estimates the output distribution parameters.

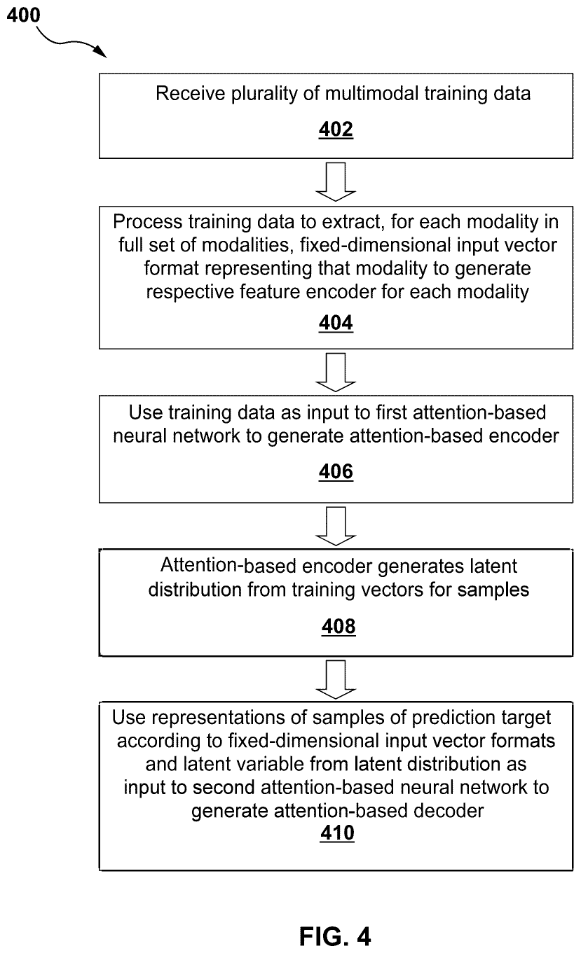

Reference is now made to FIG. 4, which shows an illustrative method 400 for training a first machine learning model to handle multimodal data including examples with missing modalities.

At step 402, the method 400 receives a plurality of multimodal training data. As noted, the training data comprises a plurality of samples of a prediction target. Each sample includes at least a subset of a full set of a plurality of modalities, and the samples collectively include instances of each modality within the full set of modalities.

At step 404, the method 400 processes the training data to extract, for each modality in the full set of modalities, a fixed-dimensional input vector format representing that modality to generate a respective feature encoder for each modality in the full set of modalities. At step 406, the method 400 generates an attention-based encoder. As described above, the attention-based encoder, once generated:
receives sets of training vectors in the fixed-dimensional input vector format, wherein each set of training vectors represents one of the samples; and
generates, from the training vectors for the samples, a fixed-dimensional vector representation template for the prediction target, wherein the number of dimensions in the fixed-dimensional vector representation template is constant and is independent of the number of modalities represented by the training vectors for the samples.

Steps 404 and 406 may be carried out using the training data as input to a first attention-based neural network. The attention-based encoder may comprise a plurality of transformer layers, and each transformer layer may comprise a multihead self-attention (MSA) portion, a layer normalization (LN) portion and a multilayer perceptron (MLP) portion applied using residual connections.

Steps 408 to 410 describe one illustrative embodiment of the method 400 in which the prediction engine is an attention-based decoder that is part of the first machine learning model, and the method 400 further comprises using the training data to train an attention-based decoder jointly with generating the attention-based encoder.

At step 408, according to the method 400 the attention-based encoder generates, from the training vectors for the samples, a latent distribution. At step 410, the method 400 uses both the representations of the samples of the prediction target according to the fixed-dimensional input vector format and a latent variable from the latent distribution as input to a second attention-based neural network to generate the attention-based decoder. Once generated, the attention-based decoder is adapted to:
receive representations of the examples of the prediction target according to the fixed-dimensional input vector format; and
generate, from the representations of the examples of the prediction target according to the fixed-dimensional input vector format and the latent variable from the latent distribution, predictions for the examples of the prediction target.

In other embodiments, the prediction engine may be a trained neural network, which may be obtained by using the representations of the samples according to the fixed-dimensional input vector format to train an untrained neural network. The trained neural network may be a multilayer perceptron (MLP) neural network.

In still other embodiments, the prediction engine may be a second machine learning model that is different from the first machine learning model, and the second machine learning model may be trained independently in a separate operation from generating the attention-based encoder.

### Human Trajectory Prediction

As noted above, for purposes of illustration and not limitation, a specific instantiation of the model for the trajectory prediction task has been described, and is evaluated on multimodal trajectory prediction datasets.

### Related Works

There have been many previous works in the domain of human navigational intent inference. The majority of these studies focus on future human motion trajectory prediction. This section will briefly review previous works on human-human interaction modeling, data-driven models for trajectory prediction, and end goal-conditioned intent inference.

### Human-Human Interaction Modeling

Human-human interaction is an important feature for accurately predicting human motion behaviours in crowds. Modeling human-human interaction has already been studied extensively in human trajectory prediction research. Early works utilize social forces to model social interactions with attractive and repulsive forces that are based on the relative distances of agents. However, these handcrafted features are often not robust enough for modeling complex social interactions. Therefore, more recent works began using learning-based methods to model complex human behaviors. Social-LSTM collects neighbouring agents' information into a grid-based pool to capture the social interactions and Social-GAN introduces a max-pooling based method to extract useful information from the surrounding neighbours. Social Ways employs an attention pooling based on neighbours' pre-defined geometric features, and other attention-based methods use learned feature vectors as the input to the attention module. Graph representations have become another popular method to model the social interaction among agents and promising results have been shown especially when combining with the attention mechanism.

### Data-Driven Models for Trajectory Prediction

The human trajectory prediction problem requires the data-driven models to have the ability to understand temporal data. As this is a sequence prediction task, early data-driven methods propose Recurrent Neural Networks (RNNs) such as Long Short Term Memories (LSTMs) to encode and decode the human motion data, and these models often have deterministic outputs. More recent studies have begun to develop data-driven models that produce probabilistic outputs. Multiple Generative Adversarial Network (GAN) based methods and CVAE models have been proposed to generate multimodal future human trajectories. Also, to accommodate the graph representation of the social interactions, Graph Convolutional Neural Networks (GCNNs) and Graph Attention Networks (GATs) are implemented to learn the spatio-temporal graph representations of social agents.

### End Goal Conditioned Intent Inference

While most prior works focus on predicting the entire future trajectories from the beginning, some works propose to estimate the final intent or end goal of the agent first before generating or reconstructing the whole trajectories. For example, Rehder et al. (2018) propose a system that first infers possible destinations of pedestrians with a mixture density function and then predicts the trajectories with these destinations based on common behavior patterns. In another example, Rhinehart et al. (2019) introduce a multi-agent forecasting model called PREdiction Conditioned on Goals (PRECOG) which is able to condition on one agent's goal when making predictions on other agents, and their experimental results show that the model's performance improve when the model is goal-conditioned. In yet another example, Mangalam et al. (2020) propose an endpoint conditioned Variable AutoEncoder (VAE), which first estimates a latent distribution based on past trajectories and future end goal, and then predicts a future trajectory using the plausible future goal sampled from the estimated latent distribution. More recently, Zhang et al. (2021) propose a hybrid framework that utilizes a learning-based method to predict only the end goals, and classical control theoretic methods to reconstruct the trajectories from the predicted end goals.

### Application of the Present Model to Multimodal Trajectory Prediction

In the trajectory prediction domain, it is very common to process multimodal features separately first and then fuse them together for inference. In this setting, each modality is encoded into a separate feature representation and then concatenated. The benefit of this approach is that it allows each modality to learn its representation independently and avoid the possibility of affecting other modalities. However, there are drawbacks to this approach. First, the concatenation is not able to handle missing modalities, which as noted above is a very common problem in real world applications. Second, encoding each modality independently does not capture the cross-modal correlations between the modalities. To overcome the drawback, the illustrative models described herein employ independent encoders to encode modalities, and utilize transformer architecture for multimodal fusion.

As defined earlier, the input to the decoder is a set of feature representations H and latent variable z. Feature representation H contains representations of all available modalities, and has a maximum size of N. By default, if no feature is missing, the decoder output D_{T}(O; ϕ) has a size of [symbol] ^{N×d}. For a dataset that has only N−1 input features, a network according to the present disclosure can still have an output with the same size [symbol] ^{N×d} with no retraining or additional modification. Because a change in the input size only affects the dimensions of K and V in the decoder, the Q matrix in the decoder always has a fixed size that matches the maximum size of the input, which always results in the same output size. In other words, the design of the transformer decoder can accept an arbitrary size of input and produce an output with same length.

The human trajectory prediction task is used to illustrate, without limitation, certain characteristics of the approach described in the present disclosure. In the human trajectory prediction task, consider an agent that is continuously moving around in a space and has been observed from 0 to t. The goal is to infer the future trajectory Y during t+1 to T based on multimodal features X. Stated another way, the goal is to predict the future trajectory for the next T time steps based on multimodal features [symbol] representing the past and the current state.

The principles described above are applied with slight modifications to the desired probability distribution, which is specifically optimized based on the human trajectory prediction task. Again, the methods described herein are not limited to human trajectory prediction.

### Goal Conditioned Prediction

For human trajectory prediction, without being limited by theory, it is hypothesized that it is more beneficial to estimate the long-term goal y^{t+T} of the future trajectory Y first, and then use this estimation along with other features to reproduce the whole sequence. The long-term goal of the future trajectory is denoted as g=y^{t+T} and used to model the conditional likelihood p_{θ}(Y|X).

### Feature Encoding

Multimodal features vary from dataset to dataset; some of the most common features are past trajectory, body pose, and neighbor information, among others. Each of the modalities is encoded with a different encoder Eₚ, depending on the type of the feature. The future goal g is also encoded as one of the modalities, although this modality will only be used during training. One advantage of this approach is that anything that can be represented as a vector can be encoded as a modality, including some annotations. Thus, annotations that will be used at training time but will not be present at inference time can be encoded as modalities.

### Loss Function

Normally for CVAEs, the loss for a sample (x, y) is optimized by the evidence lower-bound (ELBO):

$$ELBO = {𝔼}_{{q}_{φ} ( z \vert x , y )} [ log {p}_{ϕ} ( y \vert x , z ) ] - {D}_{KL} [ {q}_{φ} ( z \vert x , y ) ‖ {p}_{θ} ( z \vert x ) ] \qquad ( 24 )$$

where q_{φ}(z|x, y) is a distribution for sampling the latent variable z, and D_{KL} is the Kullback-Liebler (KL) Divergence. The first term in Equation 24 can be written as a reconstruction loss, and the goal is to maximize the ELBO. Therefore, to train the entire network end to end, the loss function is defined as:

$$L = α {D}_{KL} [ {q}_{φ} ( z \vert X , {y}^{t + T} , C ) ‖ {p}_{θ} ( z \vert X , C ) ] + β {‖ \hat{Y} - Y ‖}^{2} + γ {‖ {\hat{y}}^{t + T} - {y}^{t + T} ‖}^{2} \qquad ( 25 )$$

where α, β and γ are weighting factors. The first term is KL divergence that encourages the latent variable to be plausible and follow the prior distribution. This term can be further written as: D_{KL}[ [symbol] (μ, σ)| [symbol] (0, I)]. The second term encourages the predicted future trajectory to be close to the ground truth. The last term regularizes the transformer encoder and decoder to predict an accurate future endpoint.

### Experiments

### Datasets

Performance of the model described herein on the human trajectory prediction task was evaluated with three major multimodal trajectory prediction datasets: TISS, PIE and SFU-Store-Nav. Due to the different environments of the dataset, slightly different implementations of the model were used for each dataset, the findings for each of which are described below.

TISS is a human trajectory forecasting dataset collected from an egocentric viewpoint. The acronym “TISS” comes from the names of the institutions of the authors who developed the dataset: Tencent Robotics X, Imperial College London, Stanford University and Shanghai Jiao Tong University. The dataset consists of egocentric camera recordings of humans wearing the cameras while moving in crowded spaces. There are four modalities in this dataset: trajectory, neighbour information, semantic map, and depth map. The dataset contains 12,492 unique trajectories, and 9,992 of them are the training set, 2,500 of them are the testing set. The observation period of this dataset is 1.5 s and the prediction duration is 3.5 s at 2 fps.

Pedestrian Intention Estimation (PIE) is a large-scale pedestrian trajectory prediction dataset that contains over 6 hours of video recording of pedestrian behavior in an urban environment. 1,842 pedestrian samples are divided into a training and testing set. PIE provides annotations of a bounding box for the pedestrians, and sensor data for ego-vehicle. The evaluation of the model utilized four modalities in this dataset: trajectory, grid location, ego-vehicle motion and semantic map. Following the prior work on this dataset, the observation period is 0.5 s and the prediction duration is 1 s.

SFU-Store-Nav dataset is an indoor human-robot interaction dataset, which contains video recording of human behaviors and motion capture data of the human participants. Approximately 25,000 trajectories were extracted from over 3.6 hours of recordings. The dataset provides three modalities: trajectory, human body pose and human head orientation. Similar to prior work, the observation period is 2.6 s and future prediction duration is 2.6 s for testing using the SFU-Store-Nav dataset. The acronym “SSN” is used to refer to the SFU-Store-Nav dataset in the tables below.

### Metrics

The motion prediction metrics used for evaluating the performance of the human trajectory prediction task were Average Displacement Error (ADE) and Final Displacement Error (FDE). Final Displacement Error (FDE) is the L2 distance between predicted final goal location and ground-truth final goal location. Average Displacement Error (ADE) is the L2 distance between the predictions and ground-truth future for the whole trajectory. Mathematically,

$$\begin{matrix}ADE = \frac{1}{T} {\sum }_{i = t + 1}^{t + T} {‖ {\hat{y}}^{i} - {y}^{i} ‖}_{2} , \\ FDE = {‖ {\hat{y}}^{t + T} - {y}^{t + T} ‖}_{2} ,\end{matrix} \qquad ( 26 )$$

### Implementation Details

For the results shown in Tables 6 and 7, the goal-conditioned prediction approach is used. The last time step of the trajectory to predict is added as one of the input modalities of the amortized inference network q(z| [symbol] ∩{y^{T}}; ϕ), which is used only during training. A model according to an aspect of the present disclosure is trained using an Adam optimizer with a batch size of 512 for 300 epochs. Training on the TISS dataset used a learning rate of 10⁻³, and training on the PIE and SNN dataset used a learning rate of 10⁻⁴. Twenty predictions were sampled during inference.

### Baselines

The model according to the present disclosure was compared with several publicly available baseline methods, which include previous state-of-the-art methods. The baselines used for comparison were:
Future Person Localization (FPL), which has a 1D convolution-deconvolution architecture and predicts future person locations based on multimodal features from egocentric videos, and is described by Takuma Yagi, Karttikeya Mangalam, Ryo Yonetani, and Yoichi Sato in “Future person localization in first-person videos”, available at https://openaccess.thecvf.com/content_cvpr_2018/papers/Yagi_Future_Person_Localization_CVPR_2018_paper.pdf);
Future Object Localization (FOL), which is described by Yu Yao, Mingze Xu, Yuchen Wang, David J. Crandall and Ella M. Atkins in “Unsupervised Traffic Accident Detection in First-Person Videos” available at https://arxiv.org/pdf/2111.00993.pdf;
B-LSTM, which is described by Apratim Bhattacharyya, Mario Fritz, and Bernt Schiele in “Long-Term On-Board Prediction of People in Traffic Scenes under Uncertainty”, available at https://arxiv.org/pdf/1711.09026.pdf.
LF-LSTM, which is described by Paul Pu Liang, Yiwei Lyu, Xiang Fan, Zetian Wu, Yun Cheng, Jason Wu, Leslie Chen, Peter Wu, Michelle A. Lee, Yuke Zhu, Ruslan Salakhutdinov, and Louis-Philippe Morency in “MultiBench: Multiscale Benchmarks for Multimodal Representation Learning” available at https://arxiv.org/abs/2107.07502.
Multi-stream LSTM (MS-LSTM), which is a LSTM encoder-decoder network and uses individual LSTM to encode each feature, with encoded features concatenated and merged using fully connected layers (see https://arxiv.org/pdf/2111.00993.pdf);
LIP-LSTM, which is a single-stream LSTM encoder-decoder network where all input modalities are concatenated together, which is described by Jianing Qiu, Frank P.-W. Lo, Xiao Gu, Yingnan Sun, Shuo Jiang and Benny Lo in “Indoor Future Person Localization from an Egocentric Wearable Camera” available at https://cvgl.stanford.edu/papers/CVPR16_Social_LSTM.pdf.
LSTM-M, which is described by Alexandre Alahi, Kratarth Goel, Vignesh Ramanathan, Alexandre Robicquet, Li Fei-Fei, and Silvio Savarese in “Social LSTM: Human trajectory prediction in crowded spaces” available at https://cvgl.stanford.edu/papers/CVPR16_Social_LSTM.pdf.
CXA-Transformer, which is a transformer-based encoder-decoder neural network that takes multimodal input with a cascaded cross-attention mechanism that fuses multiple modalities, and is designed for human trajectory forecasting. CXA-Transformer is described by Jianing Qiu, Lipeng Chen, Xiao Gu, Frank P-W Lo, Ya-Yen Tsai, Jiankai Sun, Jiaqi Liu, and Benny Lo in “Egocentric human trajectory forecasting with a wearable camera and multi-modal fusion” available at https://arxiv.org/pdf/2111.00993.pdf;
Pedestrian Intention Estimation (PIE), which is an RNN encoder-decoder architecture with two types of attention module: a temporal attention module to learn the observation sequences, and a self-attention module to perform dimension reduction. The PIE method (and related dataset) is described by Amir Rasouli, Iuliia Kotseruba, Toni Kunic, and John K Tsotsos in “PIE: A large-scale dataset and models for pedestrian intention estimation and trajectory prediction” available at https://openaccess.thecvf.com/content_ICCV_2019/papers/Rasouli_PIE_A_Large-Scale_Dataset_and_Models_for_Pedestrian_Intention_Estimation_ICCV_2019_paper. pdf; and
Navigational Intent Inference (NavInt), formerly referred to as MHF, which is a hybrid framework that uses LSTM-CNN to process multimodal features, with features encoded independently and concatenated for computing future prediction, described by Zhitian Zhang, Jimin Rhim, Angelica Lim, and Mo Chen in “A multimodal and hybrid framework for human navigational intent inference” available at https://ieeexplore.ieee.org/document/9635900.

### Results

Models according to the present disclosure were first compared with other baselines using full modalities for all three datasets, and then compared to the baselines with missing modality. To evaluate the performance on missing modality, the model is assumed to have access to the full modality data during training, while the testing data are modal-incomplete.

Tables 1 to 6 show the results according to a first tuning and evaluation protocol. Tables 6A, 7 and 8 show the results according to a second, improved tuning and evaluation protocol.

Tables 1, 3 and 4 show results for TISS, PIE and SFU-Store-Nav, respectively, using full modality under the first tuning and evaluation protocol. On these datasets, results from models according to the present disclosure either achieve state-of-the-art performance (i.e. exceed the performance of the previous state of the art), or are on par with the previous state-of-the-art results. On the TISS dataset, both the ADE and the FDE are reduced, with an increase in the performance. On the PIE dataset, performance on the FDE is comparable to the prior state-of-the-art performance while maintaining the robustness of the model for handling missing modalities, and as the FDE measures the final displacement error of the trajectory, it is more beneficial to have strong performance on the FDE. On the SFU-Store-Nav dataset, models according to the present disclosure outperform all the baseline methods in both the ADE and the FDE. The results demonstrate the effectiveness of models according to the present disclosure for data with complete modality.

Tables 2, 3 and 5 show results for TISS, PIE and SFU-Store-Nav with missing modality. For testing purposes, one modality is removed randomly from the testing data and the performance is reported on the available baselines and on the model according to the present disclosure. On the TISS dataset, results are reported in Table 2 for when either neighbour body pose feature p or scene semantics s is removed from the testing data. A model according to the present disclosure outperforms the officially reported results of the CXA-Transformer across different settings. The term “CXA” is an acronym for cross-attention. When there is a missing modality, the ADE performance for a model according to the present disclosure decreases less than the decrease for the baseline method. A model according to the present disclosure with missing modality even outperformed the modal-complete baseline. The results also show that scene semantics s is a more important modality compared to neighbour body pose p. For the PIE dataset, the results on missing modality are reported in Table 3. While there are no officially reported results for modal-incomplete data for prior methods, a model according to the present disclosure model can still maintain comparable FDE performance when a modality is missing. Table 5 reports results on missing modality for the SFU-Store-Nav dataset. In this dataset, a model according to the present disclosure outperforms the baseline model on FDE both when body pose modality is missing, and also when head orientation modality is missing. Moreover, the decrease in performance is significantly lower for model according to the present disclosure than the baseline model. The results also show that the head orientation modality is a relatively more important modality than the body pose modality.

TABLE 1
Baseline Comparison on TISS dataset.

| Method | ADE | FDE |
|---|---|---|
| FPL | 0.031 | 0.0851 |
| LIP-LSTM | 0.029 | 0.067 |
| Multi-Stream LSTM | 0.028 | 0.066 |
| CXA-Transformer | 0.015 | 0.042 |
| PRESENT DISCLOSURE | 0.01089 | 0.03363 |

TABLE 2
Missing Modality Comparison on TISS dataset.

| Method | Modality | ADE | FDE |
|---|---|---|---|
| CXA-Transformer | 2*y + p | 0.039 | — |
| PRESENT DISCLOSURE | | 0.016 | 0.054 |
| CXA-Transformer | 2*y + s | 0.027 | — |
| PRESENT DISCLOSURE | | 0.013 | 0.035 |
| CXA-Transformer | 2*y + p + s | 0.015 | 0.042 |
| PRESENT DISCLOSURE | | 0.012 | 0.034 |

TABLE 3
Baseline Comparison on PIE dataset.

| Method | ADE | FDE |
|---|---|---|
| FOL | 73.87 | 164.53 |
| FPL | 56.66 | 132.23 |
| B-LSTM | 27.09 | 66.74 |
| PIE | 19.50 | 45.27 |
| PRESENT DISCLOSURE | 26.13 | 47.19 |
| Present Disclosure without semantic maps | 28.33 | 51.61 |
| Present Disclosure without vehicle motion | 32.2 | 54.12 |
| Present Disclosure without grid location | 29.34 | 53.14 |

TABLE 4
Baseline Comparison on SSN dataset.

| Method | ADE | FDE |
|---|---|---|
| LSTM-M | 0.48 | 0.65 |
| FPL | 0.35 | 0.64 |
| Multi-stream LSTM | 0.34 | 0.51 |
| NavInt (MHF) | 0.39 | 0.27 |
| PRESENT DISCLOSURE | 0.16 | 0.23 |

TABLE 5
Missing Modality Comparison on SSN dataset.

| Method | Modality | ADE | FDE |
|---|---|---|---|
| NavInt (MHF) | 2*m | 0.47 | 0.59 |
| PRESENT DISCLOSURE | | 0.33 | 0.48 |
| NavInt (MHF) | 2*m + p | 0.43 | 0.44 |
| PRESENT DISCLOSURE | | 0.29 | 0.37 |
| NavInt (MHF) | 2*m + h | 0.41 | 0.33 |
| PRESENT DISCLOSURE | | 0.21 | 0.28 |
| NavInt (MHF) | 2*m + p + h | 0.39 | 0.27 |
| PRESENT DISCLOSURE | | 0.16 | 0.23 |

In Tables 6 and 6A, results are reported for different fusion methods for the TISS and SSN datasets. The fusion of a set of modalities may be a component of a model according to the present disclosure. Table 6 reports results under the first tuning and evaluation protocol; these results show that the model has better results on both datasets and outperforms all the other fusion methods. The results in Table 6A for the second tuning and evaluation protocol show that the fusion method according to the present disclosure outperforms existing fusion methods, including the cross-attention fusion method introduced by Jianing Qiu, Lipeng Chen, Xiao Gu, Frank P-W Lo, Ya-Yen Tsai, Jiankai Sun, Jiaqi Liu, and Benny Lo in “Egocentric human trajectory forecasting with a wearable camera and multi-modal fusion” available at https://arxiv.org/pdf/2111.00993.pdf. Without being limited by theory, one benefit of the attention-based mechanism in models according to the present disclosure may be the ability to accommodate situations where the modalities are not of equal importance.

TABLE 6
Fusion Method Comparison on TISS and
SSN datasets (first protocol).

| | TISS | | SSN | |
|---|---|---|---|---|
| Fusion Method | ADE | FDE | ADE | FDE |
| Linear Fusion | 0.02 | — | 0.39 | 0.27 |
| Average Fusion | 0.025 | — | 0.45 | 0.38 |
| Sum Fusion | — | — | 0.51 | 0.66 |
| CXA Fusion | 0.015 | 0.042 | — | — |
| Present Disclosure with Average | 0.016 | 0.058 | 0.22 | 0.34 |
| Present Disclosure with Sum | 0.031 | 0.055 | 0.27 | 0.39 |
| PRESENT DISCLOSURE | 0.012 | 0.034 | 0.16 | 0.23 |

TABLE 6A
Fusion Method Comparison on TISS and
SSN datasets (second protocol).

| | TISS | | SSN | |
|---|---|---|---|---|
| Fusion Method | ADE | FDE | ADE | FDE |
| Linear Fusion | 0.14 | 0.34 | 0.39 | 0.27 |
| Average Fusion | 0.15 | 0.48 | 0.41 | 0.38 |
| Sum Fusion | — | — | 0.51 | 0.66 |
| CXA Fusion | 0.12 | 0.21 | — | — |
| Present Disclosure with Average | 0.13 | 0.24 | 0.39 | 0.50 |
| PRESENT DISCLOSURE | 0.10 | 0.18 | 0.22 | 0.26 |

Table 7 compares the results for models according to the present disclosure and for existing models when all the modalities are available during both training and testing, this time using the second tuning and evaluation protocol. A model according to the present disclosure obtains the best performance on most of the datasets, and obtains the second-best performance on the PIE dataset, slightly underperforming the PIE model. The PIE model is complex and carefully designed for the trajectory prediction task; moreover, the PIE model can only be evaluated on the PIE dataset, whereas a model according to the present disclosure is generic. On SSN, a model according to the present disclosure significantly outperforms all baseline models. In Table 7, the best performance is highlighted in bold and the second best is underlined.

TABLE 7
Baseline Comparison on TISS, PIE and SSN datasets.

| Dataset | TISS | | PIE | | SSN | |
|---|---|---|---|---|---|---|
| Metric | ADE | FDE | ADE | FDE | ADE | FDE |
| FPL | 0.177 | 0.291 | 56.66 | 132.23 | 0.356 | 0.641 |
| MS-LSTM | 0.170 | 0.259 | 43.12 | 81.78 | 0.341 | 0.416 |
| CXA-Transformer | 0.124 | 0.205 | — | — | — | — |
| PIE | — | — | 19.50 | 45.27 | — | — |
| NavInt | — | — | — | — | 0.397 | 0.271 |
| PRESENT DISCLOSURE | 0.104 | 0.181 | 25.13 | 49.19 | 0.223 | 0.264 |

Table 8 compares model performance when some modalities are missing during testing, using the second tuning and evaluation protocol. The model has access to all modalities during training, but some modalities are missing during testing. For each dataset, a model according to the present disclosure is trained only once and works with different missing modalities. All baseline models require modification to the architecture and retraining for each setting of missing modalities. The results summarized in Table 8 show that a model according to an aspect of the present disclosure has good performance without retraining. For example on TISS, when either neighbour body pose feature p or scene semantics feature s is removed during testing, a model according to the present disclosure outperforms the second-best model, CXA-Transformer. When there is a missing modality, the ADE performance of a model according to the present disclosure only decreases between 8%-17%, which is significantly better than 24%-37% for other baseline models. On the PIE dataset, a model according to the present disclosure has similar performance to the PIE model, which is specific to this dataset, but a model according to the present disclosure significantly outperforms other baselines. The PIE model needs to be retrained for each setting of missing modalities, whereas a model according to the present disclosure does not need to be retrained. On SSN, a model according to the present disclosure significantly outperforms the other models in both settings. In Table 8, the best performance is highlighted in bold and the second best is underlined.

TABLE 8
Missing Modality Comparison (ADE/FDE) on TISS, PIE and SSN datasets.

| Dataset | TISS | | PIE | | SSN | |
|---|---|---|---|---|---|---|
| Metric | t, p | t, S | t, s, e | t, s, g | t, p | t, h |
| FPL | 0.336/0.465 | 0.341/0.481 | 77.67/150.12 | 81.79/155.35 | 0.463/0.671 | 0.429/0.655 |
| MS-LSTM | 0.311/0.433 | 0.284/0.398 | 50.13/97.39 | 55.44/101.12 | 0.422/0.688 | 0.418/0.631 |
| CXA-Transformer | 0.198/0.382 | 0.164/0.291 | — | — | — | — |
| PIE | — | — | 24.82/53.74 | 27.81/62.12 | — | — |
| NavInt | — | — | — | — | 0.431/0.547 | 0.445/0.519 |
| PRESENT DISCLOSURE | 0.126/0.242 | 0.114/0.187 | 26.34/52.14 | 31.96/58.01 | 0.337/0.477 | 0.311/0.457 |

### Robot Manipulation

Additional experiments were conducted based on robot manipulation. For these experiments, a robot arm is performing a manipulation task with an object and has been observed for a sequence of time. The goal is to predict either the robot's end-effector pose or the object pose in the next T time steps based on the multimodal sensor inputs [symbol] of the past.

### Datasets

MuJoCo Push (see https://github.com/pliang279/MultiBench/) and Vision&Touch (see https://sites.google.com/view/visionandtouch) are both large scale multimodal datasets which contain the manipulation of simulated/real robotic arms in three modalities: image i, force sensor ƒ, and proprioception sensors p.

### Metric

Performance was evaluated by computing the mean square error (MSE) between the prediction and the ground truth.

### Implementation Details

A model according to the present disclosure was trained using an Adam optimizer with a batch size of 128 for 20 epochs on the robot manipulation tasks. Training on MuJoCo Push used a learning rate of 10⁻⁵, and training on Vision&Touch used a learning rate of 5×10⁻⁴.

### Baseline Models

A model according to the present disclosure was compared with several publicly available baseline models. LF-LSTM is a late fusion LSTM model where each of the modalities are processed with different encoders and then fed into separate LSTMs. Sensor Fusion (see https://ai.stanford.edu/blog/selfsupervised-multimodal/) encodes multimodal features using a variational Bayesian method. Multimodal Trans-former (MULT) (see https://github.com/yaohungt/Multimodal-Transformer) which applies cross-attention onto different modalities, and then concatenates the resulted representations for final prediction.

### Results

Table 9 compares the results of a model according to the present disclosure and the baseline models for multiple settings of missing modalities. The protocol described in the human trajectory prediction section was used to evaluate the model performances when some modalities are missing during testing. A model according to the present disclosure has the best performance in five of the six settings, and has the second-best on the last setting. When some modalities are missing (i, ƒ and i, p settings), the performance drop is significantly lower for a model according to the present disclosure than for the baseline models. These results demonstrate the effectiveness of a model according to the present disclosure when evaluated with missing modalities. In Table 9, the best performance is highlighted in bold and the second best is underlined.

TABLE 9
Baseline Comparison on robot manipulation datasets.

| | | | |
|---|---|---|---|
| Modality | i, f, p | i, f | i, p |

MuJoCo

| | | | |
|---|---|---|---|
| LF-LSTM | 0.290 | 0.583 | 0.551 |
| SensorFusion | 0.573 | 0.797 | 0.667 |
| MULT | 0.402 | 0.635 | 0.549 |
| PRESENT DISCLOSURE | 0.199 | 0.287 | 0.235 |

Vision&Touch

| | | | |
|---|---|---|---|
| LF-LSTM | 0.205 | 1.794 | 0.338 |
| SensorFusion | 0.258 | 1.981 | 0.391 |
| MULT | 0.262 | 1.134 | 0.429 |
| PRESENT DISCLOSURE | 0.237 | 0.872 | 0.271 |

### Robustness

A model according to an aspect of the present disclosure was evaluated when trained with missing modalities, to enable robustness of the model to be assessed. Table 10 shows the results on TISS when some semantic map modality samples are missing in the training data. For this analysis, a ratio of missing modality is defined as the number of missing samples. In Table 10, “100%” denotes complete modality, “50%” indicates 50% of semantic map s samples were removed, and “0%” indicates no s samples were presented in the data. The results show that when there is missing training data, a model according to the present disclosure (1) could still maintain a good level of performance relative to the baseline models for TISS shown in Table 7, and (2) benefits from having access to full modalities during training, as compared to existing models that can only work with reduced training data due to the missing modality. Adding the loss [symbol] ₘᵢₛ (defined in equation (12) above) increases the FDE performance by 64% when testing with modal-complete data, and by 79% with modal-incomplete data, which validates the effectiveness of a model according to the present disclosure in multiple settings.

TABLE 10
Ablation study of missing training data and effectiveness
of [symbol] ₘᵢₛ on TISS dataset.

| Method | Training | Testing | ADE | FDE |
|---|---|---|---|---|
| PRESENT DISCLOSURE | 100% | 100% | 0.104 | 0.181 |
| | 100% | 0% | 0.126 | 0.232 |
| | 50% | 100% | 0.143 | 0.247 |
| | 50% | 0% | 0.181 | 0.371 |
| CXA-Transformer | 50% | 100% | 0.217 | 0.465 |
| Present Disclosure without [symbol] ₘᵢₛ | 100% | 100% | 0.169 | 0.511 |
| | 100% | 0% | 0.316 | 0.873 |

### Visualization of the Latent Space.

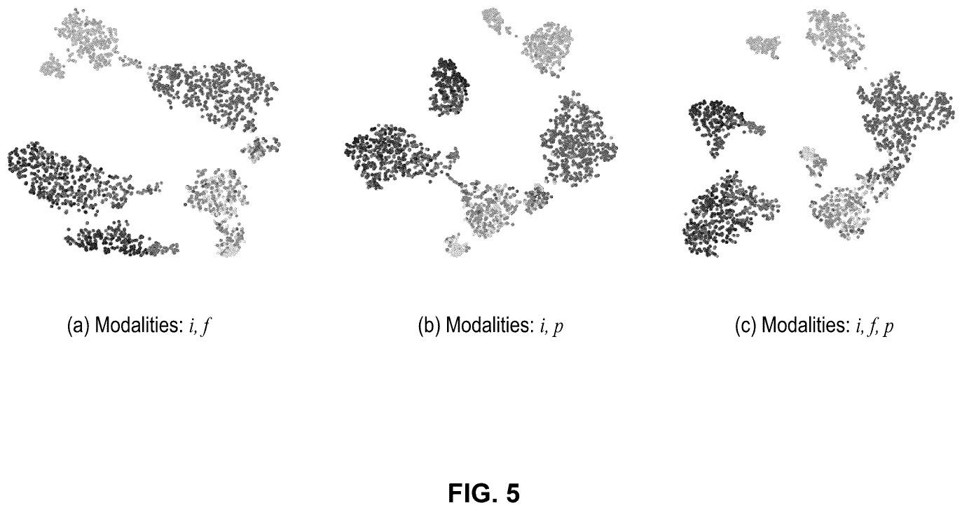

FIG. 5 shows visualizations of the latent distribution for MuJoCo Push for a model according to the present disclosure. It may be observed that the latent distributions generated from missing modalities, as shown in parts (a) and (b) of FIG. 5, are comparable to the one generated by all modalities as shown in part (c) of FIG. 5. Furthermore, part (b) of FIG. 5 looks more similar to part (c) than to part (a), indicating that modality p is a more important component than modality ƒ, which is also consistent with the results in Table 9.

As can be seen from the above description, the methods for transforming multimodal data including examples with missing modalities into a consistent fixed-dimensional representation as described herein, and predicting from these representations, represent significantly more than merely using categories to organize, store and transmit information and organizing information through mathematical correlations. The technology described herein is in fact an improvement to the technology of multimodal machine learning, providing two distinct benefits: (1) model performance can be improved by training the model on a larger dataset since samples with missing modalities may be included; and (2) during the inference phase, the model will be robust to examples with a missing modality. The technology described herein is confined to multimodal machine learning applications, and is directed to improving aspects of the computer-specific problem of handling multimodal data with missing modalities.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

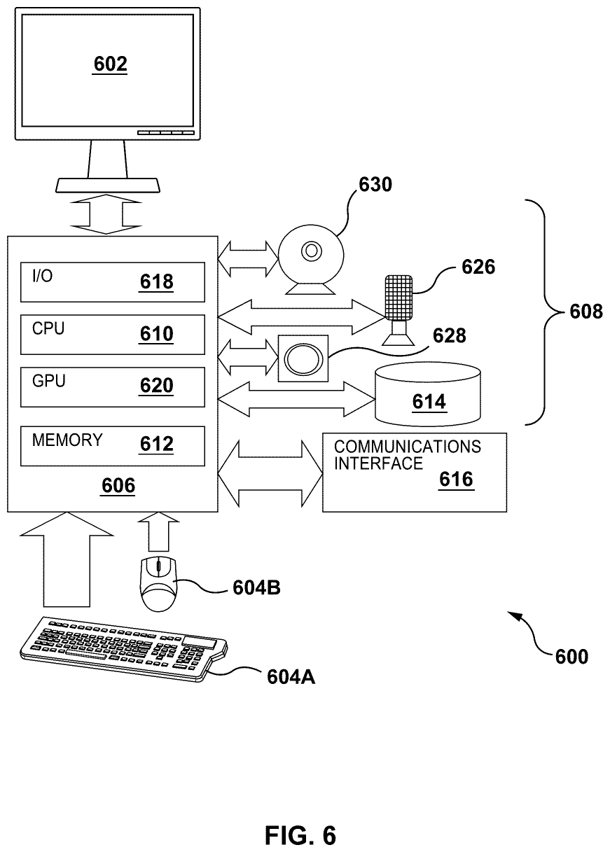

An illustrative computer system in respect of which the technology herein described may be implemented is presented as a block diagram in FIG. 6. The illustrative computer system is denoted generally by reference numeral 600 and includes a display 602, input devices in the form of keyboard 604A and pointing device 604B, computer 606 and external devices 608. While pointing device 604B is depicted as a mouse, it will be appreciated that other types of pointing device, or a touch screen, may also be used.

The computer 606 may contain one or more processors or microprocessors, such as a central processing unit (CPU) 610. The CPU 610 performs arithmetic calculations and control functions to execute software stored in an internal memory 612, preferably random access memory (RAM) and/or read only memory (ROM), and possibly additional memory 614. The additional memory 614 may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This additional memory 614 may be physically internal to the computer 606, or external as shown in FIG. 6, or both.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604A, external devices 608 and other such components of the computer system 600. The computer 606 also includes a graphical processing unit (GPU) 620. The latter may also be used for computational purposes as an adjunct to, or instead of, the (CPU) 610, for mathematical calculations.

The external devices 608 include a microphone 626, a speaker 628 and a camera 630. Although shown as external devices, they may alternatively be built in as part of the hardware of the computer system 600.

The various components of the computer system 600 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

Thus, computer readable program code for implementing aspects of the technology described herein may be contained or stored the memory 612 of the computer 606, or on a computer usable or computer readable medium external to the computer 606, or on any combination thereof.

Finally, the terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description has been presented for purposes of illustration and description, but is not intended to be exhaustive or limited to the form disclosed. Many modifications and variations will be apparent to those of ordinary skill in the art without departing from the scope of the claims. The embodiment was chosen and described in order to best explain the principles of the technology and the practical application, and to enable others of ordinary skill in the art to understand the technology for various embodiments with various modifications as are suited to the particular use contemplated.

### LIST OF REFERENCES

None of the documents cited herein is admitted to be prior art (regardless of whether or not the document is explicitly denied as such). The following list of references is provided without prejudice for convenience only, and without admission that any of the references listed herein is citable as prior art or relevant to the claimed invention.
[1] Alexandre Alahi, Kratarth Goel, Vignesh Ramanathan, Alexandre Robicquet, Li Fei-Fei, and Silvio Savarese. Social LSTM: Human trajectory prediction in crowded spaces. In IEEE Conference on Computer Vision and Pattern Recognition (CVPR), 2016.
[2] Javad Amirian, Jean-Bernard Hayet, and Julien Pettré. Social ways: Learning multi-modal distributions of pedestrian trajectories with GANS. In IEEE Conference on Computer Vision and Pattern Recognition Workshop (CVPR-W), 2019.
[3] Relja Arandjelovid and Andrew Zisserman. Objects that Sound. In European Conference on Computer Vision (ECCV), 2018.
[4] Hedi Ben-Younes, Rémi Cadene, Matthieu Cord, and Nicolas Thome. Mutan: Multimodal tucker fusion for visual question answering. In IEEE International Conference on Computer Vision (ICCV), 2017.
[5] Gedas Bertasius, Heng Wang, and Lorenzo Torresani. Is Space-Time Attention All You Need for Video Understanding? In International Conference on Machine Learning (ICML), 2021.
[6] Holger Caesar, Varun Bankiti, Alex H. Lang, Sourabh Vora, Venice Erin Liong, Qiang Xu, Anush Krishnan, Yu Pan, Giancarlo Baldan, and Oscar Beijbom. nuScenes: A multi-modal dataset for autonomous driving. In IEEE Conference on Computer Vision and Pattern Recognition (CVPR), 2020.
[7] Junyoung Chung, Caglar Gulcehre, KyungHyun Cho, and Yoshua Bengio. Empirical Evaluation of Gated Recurrent Neural Networks on Sequence Modeling. In Advances in Neural Information Processing Systems Workshop (NeurIPS-W), 2014.
[8] Asif A. Ghazanfar and Charles E. Schroeder. Is neocortex essentially multisensory? In Trends in Cognitive Sciences, 2006.
[9] Harshayu Girase, Haiming Gang, Srikanth Malla, Jiachen Li, Akira Kanehara, Karttikeya Mangalam, and Chiho Choi. Loki: Long term and key intentions for trajectory prediction. In Proceedings of the IEEE/CVF International Conference on Computer Vision, pages 9803-9812, 2021.
[10] Phillip Isola, Jun-Yan Zhu, Tinghui Zhou, and Alexei A Efros. Image-to-image translation with conditional adversarial networks. In Proceedings of the IEEE conference on computer vision and pattern recognition, pages 1125-1134, 2017.
[11] Wonjae Kim, Bokyung Son, and Ildoo Kim. Vilt: Vision-and-language transformer without convolution or region supervision. In International Conference on Machine Learning, pages 5583-5594. PMLR, 2021.
[12] Diederik P Kingma and Jimmy Ba. Adam: A method for stochastic optimization. In International Conference on Learning Representations (ICLR), 2015.
[13] Diederik P Kingma and Max Welling. Auto-Encoding Variational Bayes. In International Conference on Learning Representations (ICLR), 2014.
[14] Hsin-Ying Lee, Hung-Yu Tseng, Jia-Bin Huang, Maneesh Singh, and Ming-Hsuan Yang. Diverse image-to-image translation via disentangled representations. In Proceedings of the European conference on computer vision (ECCV), pages 35-51, 2018.
[15] Juho Lee, Yoonho Lee, Jungtaek Kim, Adam Kosiorek, Seungjin Choi, and Yee Whye Teh. Set transformer: A framework for attention-based permutation-invariant neural networks. In International Conference on Machine Learning (ICML), 2019.
[16] Michelle A. Lee, Brent Yi, Roberto Martin-Martin, Silvio Savarese, and Jeannette Bohg. Multimodal sensor fusion with differentiable filters, 2020.
[17] Michelle A Lee, Yuke Zhu, Peter Zachares, Matthew Tan, Krishnan Srinivasan, Silvio Savarese, Li Fei-Fei, Animesh Garg, and Jeannette Bohg. Making sense of vision and touch: Learning multimodal representations for contact-rich tasks. IEEE Transactions on Robotics, 36(3):582-596, 2020.
[18] Paul Pu Liang, Yiwei Lyu, Xiang Fan, Zetian Wu, Yun Cheng, Jason Wu, Leslie Chen, Peter Wu, Michelle A Lee, Yuke Zhu, et al. Multibench: Multiscale benchmarks for multimodal representation learning. arXiv preprint arXiv:2107.07502, 2021.
[19] Paul Pu Liang, Amir Zadeh, and Louis-Philippe Morency. Foundations and recent trends in multimodal machine learning: Principles, challenges, and open questions. arXiv preprint arXiv:2209.03430, 2022.
[20] Ze Liu, Jia Ning, Yue Cao, Yixuan Wei, Zheng Zhang, Stephen Lin, and Han Hu. Video Swin Transformer. In IEEE Conference on Computer Vision and Pattern Recognition (CVPR), 2022.
[21] Mengmeng Ma, Jian Ren, Long Zhao, Sergey Tulyakov, Cathy Wu, and Xi Peng. Smil: Multimodal learning with severely missing modality. In Conference on Artificial Intelligence (AAAI), 2021.
[22] Mengmeng Ma, Jian Ren, Long Zhao, Davide Testuggine, and Xi Peng. Are multimodal transformers robust to missing modality? In IEEE Conference on Computer Vision and Pattern Recognition (CVPR), 2022.
[23] Dhruv Mahajan, Ross Girshick, Vignesh Ramanathan, Kaiming He, Manohar Paluri, Yixuan Li, Ashwin Bharambe, and Laurens van der Maaten. Exploring the Limits of Weakly Supervised Pretraining. In European Conference on Computer Vision (ECCV), 2018.
[24] Karttikeya Mangalam, Harshayu Girase, Shreyas Agarwal, Kuan-Hui Lee, Ehsan Adeli, Jitendra Malik, and Adrien Gaidon. It is not the journey but the destination: Endpoint conditioned trajectory prediction. In European Conference on Computer Vision (ECCV), 2020.
[25] Arsha Nagrani, Shan Yang, Anurag Arnab, Aren Jansen, Cordelia Schmid, and Chen Sun. Attention bottlenecks for multimodal fusion. Advances in Neural Information Processing Systems (NeurIPS), 2021.
[26] Aaron van den Oord, Sander Dieleman, Heiga Zen, Karen Simonyan, Oriol Vinyals, Alex Graves, Nal Kalchbrenner, Andrew Senior, and Koray Kavukcuoglu. Wavenet: A generative model for raw audio. arXiv preprint arXiv:1609.03499, 2016.
[27] Gaurav Pandey and Ambedkar Dukkipati. Variational methods for conditional multimodal deep learning. In 2017 international joint conference on neural networks (IJCNN), pages 308-315. IEEE, 2017.
[28] Hai Pham, Paul Pu Liang, Thomas Manzini, Louis-Philippe Morency, and Barnabás Póczos. Found in translation: Learning robust joint representations by cyclic translations between modalities. In Proceedings of the AAAI Conference on Artificial Intelligence, pages 6892-6899, 2019.
[29] Soujanya Poria, Iti Chaturvedi, Erik Cambria, and Amir Hussain. Convolutional MKL based multimodal emotion recognition and sentiment analysis. In 2016 IEEE 16th international conference on data mining (ICDM), 2016.
[30] Jianing Qiu, Lipeng Chen, Xiao Gu, Frank P-W Lo, Ya-Yen Tsai, Jiankai Sun, Jiaqi Liu, and Benny Lo. Egocentric human trajectory forecasting with a wearable camera and multi-modal fusion. IEEE Robotics and Automation Letters, 2022.
[31] Dhanesh Ramachandram and Graham W Taylor. Deep multimodal learning: A survey on recent advances and trends. IEEE signal processing magazine, 2017.
[32] Amir Rasouli, Iuliia Kotseruba, Toni Kunic, and John K Tsotsos. PIE: A large-scale dataset and models for pedestrian intention estimation and trajectory prediction. In IEEE International Conference on Computer Vision (ICCV), 2019.
[33] Tim Salzmann, Boris Ivanovic, Punarjay Chakravarty, and Marco Pavone. Trajectron++: Dynamically-feasible trajectory forecasting with heterogeneous data. In European Conference on Computer Vision (ECCV). Springer, 2020.
[34] Kihyuk Sohn, Honglak Lee, and Xinchen Yan. Learning Structured Output Representation using Deep Conditional Generative Models. In Advances in Neural Information Processing Systems (NeurIPS), 2015.
[35] Kihyuk Sohn, Honglak Lee, and Xinchen Yan. Learning structured output representation using deep conditional generative models. In Advances in Neural Information Processing Systems. Curran Associates, Inc., 2015.
[36] Robin Strudel, Ricardo Garcia, Ivan Laptev, and Cordelia Schmid. Segmenter: Transformer for semantic segmentation. In Proceedings of the IEEE/CVF international conference on computer vision, pages 7262-7272, 2021.
[37] Chen Sun, Abhinav Shrivastava, Saurabh Singh, and Abhi-nav Gupta. Revisiting Unreasonable Effectiveness of Data in Deep Learning Era. In IEEE International Conference on Computer Vision (ICCV), 2017.
[38] Chen Sun, Austin Myers, Carl Vondrick, Kevin Murphy, and Cordelia Schmid. Videobert: A joint model for video and language representation learning. In IEEE International Conference on Computer Vision (ICCV), 2019.
[39] Pei Sun, Henrik Kretzschmar, Xerxes Dotiwalla, Aurelien Chouard, Vijaysai Patnaik, Paul Tsui, James Guo, Yin Zhou, Yuning Chai, Benjamin Caine, et al. Scalability in perception for autonomous driving: Waymo open dataset. In Proceedings of the IEEE/CVF conference on computer vision and pattern recognition, pages 2446-2454, 2020.
[40] Yujin Tang and David Ha. The sensory neuron as a transformer: Permutation-invariant neural networks for reinforcement learning. In Advances in Neural Information Processing Systems (NeurIPS), 2021.
[41] Yao-Hung Hubert Tsai, Paul Pu Liang, Amir Zadeh, Louis-Philippe Morency, and Ruslan Salakhutdinov. Learning factorized multimodal representations. arXiv preprint arXiv:1806.06176, 2018.
[42] Yao-Hung Hubert Tsai, Shaojie Bai, Paul Pu Liang, J Zico Kolter, Louis-Philippe Morency, and Ruslan Salakhutdinov. Multimodal transformer for unaligned multimodal language sequences. In Proceedings of the conference. Association for Computational Linguistics. Meeting, page 6558. NIH Public Access, 2019.
[43] Yao-Hung Hubert Tsai, Martin Q. Ma, Muqiao Yang, Ruslan Salakhutdinov, and Louis-Philippe Morency. Multimodal routing: Improving local and global interpretability of multimodal language analysis, 2020.
[44] Ashish Vaswani, Noam Shazeer, Niki Parmar, Jakob Uszko-reit, Llion Jones, Aidan N Gomez, Lukasz Kaiser, and Illia Polosukhin. Attention is all you need. Advances in Neural Information Processing Systems (NeurIPS), 2017.
[45] Haohan Wang, Aaksha Meghawat, Louis-Philippe Morency, and Eric P Xing. Select-additive learning: Improving generalization in multimodal sentiment analysis. In IEEE International Conference on Multimedia and Expo (ICME), 2017.
[46] Mike Wu and Noah Goodman. Multimodal generative models for scalable weakly-supervised learning. Advances in neural information processing systems, 31, 2018.
[47] Fanyi Xiao, Yong Jae Lee, Kristen Grauman, Jitendra Malik, and Christoph Feichtenhofer. Audiovisual slowfast networks for video recognition. In IEEE Conference on Computer Vision and Pattern Recognition (CVPR), 2020.
[48] Takuma Yagi, Karttikeya Mangalam, Ryo Yonetani, and Yoichi Sato. Future person localization in first-person videos. In IEEE Conference on Computer Vision and Pattern Recognition (CVPR), 2018.
[49] Linwei Ye, Mrigank Rochan, Zhi Liu, and Yang Wang. Cross-modal self-attention network for referring image segmentation. In Proceedings of the IEEE/CVF conference on computer vision and pattern recognition, pages 10502-10511, 2019.
[50] Ye Yuan, Xinshuo Weng, Yanglan Ou, and Kris M Kitani. Agentformer: Agent-aware transformers for socio-temporal multi-agent forecasting. In IEEE International Conference on Computer Vision (ICCV), 2021.
[51] Amir Zadeh, Minghai Chen, Soujanya Poria, Erik Cambria, and Louis-Philippe Morency. Tensor fusion net-work for multimodal sentiment analysis. arXiv preprint arXiv:1707.07250, 2017.
[52] Zhitian Zhang, Jimin Rhim, Mahdi TaherAhmadi, Kefan Yang, Angelica Lim, and Mo Chen. SFU-Store-Nav: A multimodal dataset for indoor human navigation. Data in Brief, 2020.
[53] Zhitian Zhang, Jimin Rhim, Angelica Lim, and Mo Chen. A multimodal and hybrid framework for human navigational intent inference. In IEEE/RSJ International Conference on Intelligent Robots and Systems (IROS), 2021.
[54] Jun-Yan Zhu, Taesung Park, Phillip Isola, and Alexei A Efros. Unpaired image-to-image translation using cycle-consistent adversarial networks. In Proceedings of the IEEE international conference on computer vision, pages 2223-2232, 2017.
[55] Stuart Eiffert, Kunming Li, Mao Shan, Stewart Worrall, Salah Sukkarieh, and Eduardo Nebot. Probabilistic crowd GAN: Multimodal pedestrian trajectory prediction using a graph vehicle-pedestrian attention network. IEEE Robotics and Automation Letters, 5(4):5026-5033, 2020.
[56] Agrim Gupta, Justin Johnson, Li Fei-Fei, Silvio Savarese, and Alexandre Alahi. Social GAN: Socially acceptable trajectories with generative adversarial networks. In Proceedings of the IEEE Conference on Computer Vision and Pattern Recognition, pages 2255-2264, 2018.
[57] Dirk Helbing and Peter Molnar. Social force model for pedestrian dynamics. Physical review E, 51(5):4282, 1995.
[58] Vineet Kosaraju, Amir Sadeghian, Roberto Martín-Martín, Ian Reid, S Hamid Rezatofighi, and Silvio Savarese. Social-BiGAT: Multimodal trajectory forecasting using bicycle—gan and graph attention networks. arXiv preprint arXiv:1907.03395, 2019.
[59] Namhoon Lee, Wongun Choi, Paul Vernaza, Christopher B Choy, Philip H S Torr, and Manmohan Chandraker. Desire: Distant future prediction in dynamic scenes with interacting agents. In Proceedings of the IEEE Conference on Computer Vision and Pattern Recognition, pages 336-345, 2017.
[60] Ramin Mehran, Alexis Oyama, and Mubarak Shah. Abnormal crowd behavior detection using social force model. In 2009 IEEE Conference on Computer Vision and Pattern Recognition, pages 935-942. IEEE, 2009.
[61] Abduallah Mohamed, Kun Qian, Mohamed Elhoseiny, and Christian Claudel. Social-STGCNN: A social spatio-temporal graph convolutional neural network for human trajectory prediction. In Proceedings of the IEEE/CVF Conference on Computer Vision and Pattern Recognition, pages 14424-14432, 2020.
[62] Eike Rehder, Florian Wirth, Martin Lauer, and Christoph Stiller. Pedestrian prediction by planning using deep neural networks. In 2018 IEEE International Conference on Robotics and Automation (ICRA), pages 5903-5908. IEEE, 2018.
[63] Nicholas Rhinehart, Rowan McAllister, Kris Kitani, and Sergey Levine. Precog: Prediction conditioned on goals in visual multi-agent settings. In Proceedings of the IEEE/CVF International Conference on Computer Vision, pages 2821-2830, 2019.
[64] Amir Sadeghian, Vineet Kosaraju, Ali Sadeghian, Noriaki Hirose, Hamid Rezatofighi, and Silvio Savarese. Sophie: An attentive gan for predicting paths compliant to social and physical constraints. In Proceedings of the IEEE/CVF Conference on Computer Vision and Pattern Recognition, pages 1349-1358, 2019.
[65] Liushuai Shi, Le Wang, Chengjiang Long, Sanping Zhou, Mo Zhou, Zhenxing Niu, and Gang Hua. SGCN: Sparse graph convolution network for pedestrian trajectory prediction. In Proceedings of the IEEE/CVF Conference on Computer Vision and Pattern Recognition, pages 8994-9003, 2021.
[66] Anirudh Vemula, Katharina Muelling, and Jean Oh. Social attention: Modeling attention in human crowds. In 2018 IEEE international Conference on Robotics and Automation (ICRA), pages 4601-4607. IEEE, 2018.
[67] Cunjun Yu, Xiao Ma, Jiawei Ren, Haiyu Zhao, and Shuai Yi. Spatio-temporal graph transformer networks for pedestrian trajectory prediction. In European Conference on Computer Vision, pages 507-523. Springer, 2020.
[68] Yu Yao, Mingze Xu, Yuchen Wang, David J. Crandall and Ella M. Atkins. Unsupervised Traffic Accident Detection in First-Person Videos. https://arxiv.org/pdf/2111.00993.pdf.
[69] Apratim Bhattacharyya, Mario Fritz, and Bernt Schiele. Long-Term On-Board Prediction of People in Traffic Scenes under Uncertainty. https://arxiv.org/pdf/1711.09026.pdf.
[70] Paul Pu Liang, Yiwei Lyu, Xiang Fan, Zetian Wu, Yun Cheng, Jason Wu, Leslie Chen, Peter Wu, Michelle A. Lee, Yuke Zhu, Ruslan Salakhutdinov, and Louis-Philippe Morency. MultiBench: Multiscale Benchmarks for Multimodal Representation Learning. https://arxiv.org/abs/2107.07502.
[71] Jianing Qiu, Frank P.-W. Lo, Xiao Gu, Yingnan Sun, Shuo Jiang and Benny Lo. Indoor Future Person Localization from an Egocentric Wearable Camera. https://cvgl.stanford.edu/papers/CVPR16_Social_LSTM.pdf.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A method for training a first machine learning model to handle multimodal data including examples with missing modalities, the method comprising:
receiving a plurality of multimodal training data, the training data comprising a plurality of samples of a prediction target, wherein:
each sample includes at least a subset of a full set of modalities, wherein the full set of modalities is a plurality of modalities; and
the samples collectively include instances of each modality within the full set of modalities;
using the training data as input to a first attention-based neural network, comprising:
processing the training data to extract, for each modality in the full set of modalities, a fixed-dimensional input vector format representing that modality to generate a respective feature encoder for each modality in the full set of modalities;
generating an attention-based encoder that:
receives sets of training vectors in the fixed-dimensional input vector format, wherein each set of training vectors represents one of the samples; and
generates, from the training vectors for the samples, a fixed-dimensional vector representation template for the prediction target, wherein the number of dimensions in the fixed-dimensional vector representation template is constant and is independent of the number of modalities represented by the training vectors for the samples
uses the samples and the fixed-dimensional vector representation template to generate, from the training vectors for the samples, a latent distribution;
the method further comprising using:
representations of the samples of the prediction target according to the fixed-dimensional input vector format; and
the latent variable from the latent distribution;
as input to a second attention-based neural network to generate an attention-based decoder;
wherein the attention-based decoder is adapted to:
receive representations of the examples of the prediction target according to the fixed-dimensional input vector format; and
generate, from the representations of the examples of the prediction target according to the fixed-dimensional input vector format and the latent variable from the latent distribution, predictions for the examples of the prediction target.

2. The method of claim 1, wherein the attention-based decoder is part of the first machine learning model;
the method further comprising using the training data to train the attention-based decoder jointly with generating the attention-based encoder.

3. The method of claim 1, wherein:
the attention-based decoder is part of a second machine learning model that is different from the first machine learning model; and
the second machine learning model is trained independently in a separate operation from generating the attention-based encoder.

4. The method of claim 1, wherein the attention-based encoder comprises a plurality of transformer layers.

5. The method of claim 4, wherein each transformer layer comprises a multihead self-attention (MSA) portion, a layer normalization (LN) portion and a multilayer perceptron (MLP) portion applied using residual connections.

6. The method of claim 1, wherein the fixed-dimensional vector representation template has a dimensionality that is greater than a number of the full set of modalities.

7. The method of claim 1, wherein the fixed-dimensional vector representation template has a dimensionality that is fewer than a number of the full set of modalities.

8. The method of claim 1, wherein the fixed-dimensional vector representation template has a dimensionality that is equal to a number of the full set of modalities.

9. The method of claim 1, wherein the plurality of modalities is at least three modalities.

10. A computer program product comprising at least one tangible non-transitory computer-readable medium embodying instructions which, when implemented by at least one processor of a computer, cause the computer to carry out a method for training a first machine learning model to handle multimodal data including examples with missing modalities, the method comprising:
receiving a plurality of multimodal training data, the training data comprising a plurality of samples of a prediction target, wherein:
each sample includes at least a subset of a full set of modalities, wherein the full set of modalities is a plurality of modalities; and
the samples collectively include instances of each modality within the full set of modalities;
using the training data as input to a first attention-based neural network, comprising:
processing the training data to extract, for each modality in the full set of modalities, a fixed-dimensional input vector format representing that modality to generate a respective feature encoder for each modality in the full set of modalities;
generating an attention-based encoder that:
receives sets of training vectors in the fixed-dimensional input vector format, wherein each set of training vectors represents one of the samples; and
generates, from the training vectors for the samples, a fixed-dimensional vector representation template for the prediction target, wherein the number of dimensions in the fixed-dimensional vector representation template is constant and is independent of the number of modalities represented by the training vectors for the samples
uses the samples and the fixed-dimensional vector representation template to generate, from the training vectors for the samples, a latent distribution;
the method further comprising using:
representations of the samples of the prediction target according to the fixed-dimensional input vector format; and
the latent variable from the latent distribution;
as input to a second attention-based neural network to generate an attention-based decoder;
wherein the attention-based decoder is adapted to:
receive representations of the examples of the prediction target according to the fixed-dimensional input vector format; and
generate, from the representations of the examples of the prediction target according to the fixed-dimensional input vector format and the latent variable from the latent distribution, predictions for the examples of the prediction target.

11. The computer program product of claim 10, wherein the attention-based decoder is part of the first machine learning model;
the method further comprising using the training data to train the attention-based decoder jointly with generating the attention-based encoder.

12. The computer program product of claim 10, wherein:
the attention-based decoder is part of a second machine learning model that is different from the first machine learning model; and
the second machine learning model is trained independently in a separate operation from generating the attention-based encoder.

13. The computer program product of claim 10, wherein the fixed-dimensional vector representation template has a dimensionality that is greater than a number of the full set of modalities.

14. The computer program product of claim 10, wherein the fixed-dimensional vector representation template has a dimensionality that is fewer than a number of the full set of modalities.

15. The computer program product of claim 10, wherein the fixed-dimensional vector representation template has a dimensionality that is equal to a number of the full set of modalities.

16. A data processing system comprising at least one processor and memory embodying instructions which, when implemented by the at least one processor, cause the data processing system to carry out a method for training a first machine learning model to handle multimodal data including examples with missing modalities, the method comprising:
receiving a plurality of multimodal training data, the training data comprising a plurality of samples of a prediction target, wherein:
each sample includes at least a subset of a full set of modalities, wherein the full set of modalities is a plurality of modalities; and
the samples collectively include instances of each modality within the full set of modalities;
using the training data as input to a first attention-based neural network, comprising:
processing the training data to extract, for each modality in the full set of modalities, a fixed-dimensional input vector format representing that modality to generate a respective feature encoder for each modality in the full set of modalities;
generating an attention-based encoder that:
receives sets of training vectors in the fixed-dimensional input vector format, wherein each set of training vectors represents one of the samples; and
generates, from the training vectors for the samples, a fixed-dimensional vector representation template for the prediction target, wherein the number of dimensions in the fixed-dimensional vector representation template is constant and is independent of the number of modalities represented by the training vectors for the samples
uses the samples and the fixed-dimensional vector representation template to generate, from the training vectors for the samples, a latent distribution;
the method further comprising using:
representations of the samples of the prediction target according to the fixed-dimensional input vector format; and
the latent variable from the latent distribution;
as input to a second attention-based neural network to generate an attention-based decoder;
wherein the attention-based decoder is adapted to:
receive representations of the examples of the prediction target according to the fixed-dimensional input vector format; and
generate, from the representations of the examples of the prediction target according to the fixed-dimensional input vector format and the latent variable from the latent distribution, predictions for the examples of the prediction target.

17. The data processing system of claim 16, wherein the attention-based decoder is part of the first machine learning model;
the method further comprising using the training data to train the attention-based decoder jointly with generating the attention-based encoder.

18. The data processing system of claim 16, wherein:
the attention-based decoder is part of a second machine learning model that is different from the first machine learning model; and
the second machine learning model is trained independently in a separate operation from generating the attention-based encoder.

19. The data processing system of claim 16, wherein the fixed-dimensional vector representation template has a dimensionality that is greater than a number of the full set of modalities.

20. The data processing system of claim 16, wherein the fixed-dimensional vector representation template has a dimensionality that is fewer than a number of the full set of modalities.

21. The data processing system of claim 16, wherein the fixed-dimensional vector representation template has a dimensionality that is equal to a number of the full set of modalities.
